(19) United States
(12) Patent Application Publication
(10) Pub. No.: US 2014/0362205 A1
(43) Pub. Date: Dec. 11, 2014

(54) IMAGE FORMING APPARATUS AND CONTROL METHOD FOR THE SAME

(71) Applicant: CANON KABUSHIKI KAISHA, Tokyo (JP)

(72) Inventor: Toru Sasaki, Yokohama-shi (JP)

(21) Appl. No.: 14/374,672

(22) PCT Filed: Feb. 5, 2013
(86) PCT No.: PCT/JP2013/053162

§ 371 Date: Jul. 25, 2014

(30) Foreign Application Priority Data
Feb. 7, 2012 (JP) 2012-024087
Feb. 7, 2012 (JP) 2012-024150
Jan. 30, 2013 (JP) 2013-015743

(51) Int. Cl. G02B 21/36; G06T 11/60; H04N 5/232

(52) U.S. Cl. CPC G02B 21/367; H04N 5/23229; G06T 11/60; G06T 2207/10056; G06T 2207/20221
USPC 348/79

(57) ABSTRACT

The apparatus has a drive system that drives at least one of the imaging element and a holding member to change their positions, a drive control unit that drives the drive system, every time a small image is captured, in such a way that the positions of the imaging element and the holding member are set to predetermined positions, an obtaining unit that obtains, as after-driving position information, the position of at least one of the imaging element and the holding member after driving by the drive system by measurement or estimation, a correction unit that corrects deformation of the small images caused by a difference between the target imaging position and an actual imaging position on the basis of the after-driving position information, and a forming unit that forms an overall image of the object by stitching the small images after correction.

### TECHNICAL FIELD

The present invention relates to an image forming apparatus and a control method for the same.

### BACKGROUND ART

To eliminate the problem of shortage of pathologists and problems pertaining to medical care in remote places, the importance of diagnosis using images of pathological specimens has been increasing in recent years. Images of pathological samples are formed using a microscope having an electrically-driven stage or a medical slide scanner. (Such an apparatus will be hereinafter referred to as a digital microscope.) However, there are many technical problems to be solved to form an image that is accurate enough to allow diagnosis.

One of known technical problems is the problem concerning stitching of images. The area of a specimen that can be imaged by an objective lens of a digital microscope is smaller than the entire area of an ordinary specimen. Usually, the imaged area is smaller than one hundredth of the entire area of a specimen. Therefore, to obtain an image of the specimen in entirety, it is necessary to capture a plurality of images at different positions and to stitch them together.

Image data (which will be hereinafter referred to as a small image) is acquired by one imaging that is performed every time a specimen is shifted by a constant distance by an electrically-driven stage. However, a positional error that can occur due to looseness or play of the stage or other causes will affect the images. Consequently, image data of the entire area of the specimen (which will be hereinafter referred to as the overall image) cannot be acquired only by arranging small images, because there will be differences between small images at stitching boundaries of the small images. For this reason, small images are normally captured in such a way that the peripheries of the adjoining small images overlap with each other, and an overall image is composed after performing positional error correction in such a way that the shapes of the specimen in the overlapping portions of the adjoining small images coincide with each other.

Digital microscopes process a lot of small images. Therefore, a heavy calculation load is placed on them in estimating the amount of positional displacement, affecting the overall processing time. In the method disclosed in patent literature 1, the relationship between the image and the stage is measured beforehand based on calibration data, and the amount of positional displacement is computed based on the calibration data. This obviates the estimation of the positional displacement amount, leading to a reduction in the overall processing time.

The problem with the method disclosed in patent literature 1 is that a large number of times of calibration are required because the accuracy of the calibration data varies depending on the condition of the stage. Patent literature 2 discloses a method of reducing the number of times of calibration by estimating the amount of positional displacement when capturing adjoining small images and improving the accuracy of calibration data based on the amount of positional displacement.

The method of correcting positional displacement disclosed in patent literature 3 reduces the overall processing time by performing the estimation of the amount of positional displacement successively during the shift of the stage.

The problem concerning stitching of images is also known with imaging apparatuses other than the digital microscope. When a stereoscopic image is obtained in an imaging apparatus such as a camera, stitching of images can be difficult due to factors other than the driving mechanisms including the stage. In the imaging apparatus disclosed in patent literature 4, a picture of a large area can be formed by performing consecutive imaging while panning the imaging apparatus (for example, a camera) with hands and combining the small images thus captured. In this case, since imaging is performed while the camera is panned not by a stage but by hands, a large positional displacement that makes the estimation of the positional displacement between adjoining images based on the image analysis difficult will arise. To solve this problem, the posture of the camera at the time of imaging is estimated using a gyro sensor or the like, then image correction is performed based on the estimated value, and then the positional displacement between adjoining images is estimated.

### CITATION LIST

### Patent Literature

PTL 1: Japanese Patent Publication No. 04175597
PTL 2: Japanese Patent Application Laid-Open No. 2010-020997
PTL 3: Japanese Patent Application Laid-Open No. 2007-327907
PTL 4: Japanese Patent Application Laid-Open No. 2010-147635

### Non Patent Literature

NPL 1: R. Szeliski, Image alignment and stitching: a tutorial, Tech. Rep. MSR-TR-2004-92, Microsoft Research, December 2004.
NPL 2: S. Rao, Engineering optimization, A Wiely-Interscience Publication 1996.

### SUMMARY OF INVENTION

### Technical Problem

The definition of the driving directions (x, y, and z axes) of a drive system that a digital microscope in this specification is equipped with will be given below. An axis parallel to the optical axis will be referred to as the z axis, and axes that are perpendicular to each other in a plane perpendicular to the optical axis will be referred to as x and y axes. In the accompanying drawings, the x axis is an axis parallel to the plane of the drawing sheet, and the y axis is an axis perpendicular to the plane of the drawing sheet. In the description of a digital microscope with the optical axis bent by an inserted mirror, a further description of the x and y axes will be additionally made.

The present invention relates to a digital microscope having a plurality of drive systems. For example, the digital microscope has a three-axis (x, y, and z axes) stage for a specimen and actuators for an imaging element for driving along the z axis and for rotation about the x and y axes (tilting of the light receiving surface). The drive system for the imaging element is provided in order to vary the tilt angle of the light receiving surface thereby bringing the specimen surface in focus. In order to prevent an increase in the price with the use of a number of drive systems, inexpensive parts with low accuracy are used in the drive systems.

In the case where the digital microscope has a number of drive systems in each of which positional displacement arises, stitching of images requires estimation of many parameters relating to the positional displacement, leading to the problem of long calculation time for estimation.

The demand for diagnosis using digital images tends to be increasing, and high class apparatuses used in large hospitals are desired to be capable of performing imaging in a greatly reduced period of time. It is necessary in the future that an image of the entire area of a slide be obtained in a few seconds (which will not make the operator feel slowness of the operation). However, the positional displacement estimation process utilizing the similarity of images is a searching process using optimization or the like, which is not suitable by its nature for high speed processing. When estimation of many positional displacements is required as is the case with the apparatus according to the present invention, it is further difficult to meet the speed requirement.

It is difficult to reduce the calculation time with the method utilizing the calibration disclosed in patent literatures 1 and 2. Calibration data generated in a digital microscope having a number of drive systems is multi-dimensional calibration data. The above-mentioned digital microscope is equipped with six drive systems. When reduced to shift in the image, the positional displacements of the respective drive systems are not independent. Generation of calibration data with respect to six-dimensional non-independent variables takes a long time.

In the case where the method of correcting positional displacement disclosed in patent literature 3 is used, it is also difficult to reduce the calculation time. Small images captured by the above-mentioned digital microscope are affected by a change in the magnification caused by rotation and tilt of the image in addition to positional displacement in the image plane. If the method of correcting positional displacement disclosed in patent literature is applied to small images in order from the upper left image, the effect of rotation and magnification change on the upper left small image can prevent the lower right image from being stitched with it (due to a gap left therebetween) in some cases. This problem is known as the problem of global alignment (which is described in non-patent literature 1).

One may think of the estimation of the posture using a gyro sensor as with the method disclosed in patent literature 4 on the assumption that the imaging element moves freely. However, because the degree of accuracy of the drive system is generally higher than the degree of accuracy of the gyro sensor, the above-mentioned problem cannot be solved by this method.

An object of the present invention is to reduce the time taken to combine (or stitch) small images in an image forming apparatus that has a plurality of drive systems and forms an overall image of an imaged object by combining small images captured by performing imaging multiple times while moving the imaged object and the imaging element by drive systems.

### Solution to Problem

According to the present invention, there is provided an image forming apparatus configured to form an overall image of an object by stitching a plurality of small images captured by imaging the object a plurality of times while changing the imaging position and comprising:

an imaging element;

a holding member configured to hold an object;

at least one of a drive system configured to drive the imaging element in one or plurality of directions to change the position of the imaging element and a drive system that drives the holding member in one or plurality of directions to change the position of the holding member;

a drive control unit configured to drive the drive system, every time a small image is captured, in such a way that the positions of the imaging element and the holding member are set to predetermined positions that are determined in such a way that imaging is performed at a target imaging position;

an obtaining unit configured to obtain, as after-driving position information, at least one of the position of the imaging element with respect to the one or plurality of directions after driving by the drive system and the position of the holding member with respect to the one or plurality of directions after driving by the drive system by measurement or estimation;

a correction unit configured to correct deformation of the small images caused by a difference between the target imaging position and an actual imaging position, based on the after-driving position information; and

a forming unit configured to form an overall image of the object by stitching the small images after correction.

According to the present invention, there is provided a control method for an image forming apparatus that is provided with an imaging element, a holding member configured to hold an object, and at least one of a drive system configured to drive the imaging element in one or plurality of directions to change the position of the imaging element and a drive system that drives the holding member in one or plurality of directions to change the position of the holding member, and is configured to form an overall image of an object by stitching a plurality of small images captured by imaging the object a plurality of times while changing the imaging position, comprising:

a drive control step of driving the drive system, every time a small image is captured, in such a way that the positions of the imaging element and the holding member are set to predetermined positions that are determined in such a way that imaging is performed at a target imaging position;

an obtaining step of obtaining, as after-driving position information, at least one of the position of the imaging element with respect to the one or plurality of directions after driving by the drive system and the position of the holding member with respect to the one or plurality of directions after driving by the drive system by measurement or estimation;

a correction step of correcting deformation of the small images caused by a difference between the target imaging position and an actual imaging position, based on the after-driving position information; and

a forming step of forming an overall image of the object by stitching the small images after correction.

### Advantageous Effects of Invention

According to the present invention, in an image forming apparatus that has a plurality of drive systems and forms an overall image of an imaged object by combining together small images captured by performing imaging multiple times while moving the imaged object and the imaging element by the drive systems, the time taken to combine (or stitch) small images is reduced.

Further features of the present invention will become apparent from the following description of exemplary embodiments with reference to the attached drawings.

### BRIEF DESCRIPTION OF DRAWINGS

FIG. 1 is a diagram showing the configuration of a digital microscope according to a first embodiment.

FIG. 2 shows an example of a status table used to control the digital microscope according to the first embodiment.

FIG. 3 is a flow chart of a small image capturing process executed in the digital microscope according to the first embodiment.

FIG. 4 is a diagram showing the positions of small images capture by the digital microscope according to the first embodiment.

FIG. 5 is a flow chart of image processing performed in the digital microscope according to the first embodiment.

FIG. 6 is a diagram illustrating processing applied to an overlapping area of small images after correction.

FIG. 7 is a diagram showing the configuration of a digital microscope according to a second embodiment.

FIG. 8 is a flow chart of a process of estimating the positional displacement of a stage according to a third embodiment.

FIG. 9 illustrates a positional displacement table according to the third embodiment.

FIG. 10 is a flow chart of image processing performed in the digital microscope according to a fourth embodiment.

FIG. 11 is a flow chart of a correction parameter optimization process according to the fourth embodiment.

FIG. 12 is a diagram illustrating the relationship between pixel blocks and small images for estimation.

FIG. 13 is a diagram illustrating processing applied to an overlapping area of small images after correction.

FIG. 14 is a diagram showing the configuration of a digital microscope according to a fifth embodiment.

FIG. 15 is a flow chart of a correction parameter optimization process (by block matching) according to the fifth embodiment.

FIG. 16 is a diagram illustrating the relationship between pixel blocks and small images used in computing correction parameters in the fifth embodiment.

FIG. 17 is a diagram showing an exemplary order of selection of adjoining small image pairs in computing the correction parameters in the fifth embodiment.

FIG. 18A and FIG. 18B are flow charts of image processing performed in the digital microscope according to a sixth embodiment. FIG. 18A is a flow chart of the process executed in the image processing apparatus 109. FIG. 18B is a flow chart of the process executed in the computer 110.

### DESCRIPTION OF EMBODIMENTS

The present invention relates to an image forming apparatus that forms an overall image of an object by combining small images captured by performing imaging multiple times while changing the imaging position. The present invention can suitably be applied to, but not limited to, a digital microscope. As an embodiment, a case where the present invention is applied to a digital microscope will be described. The digital microscope according to the embodiment is provided with one or plurality of imaging elements. The digital microscope is also provided with a holding member for holding an object (specimen) (or a stage for shifting a specimen). The holding member is driven in one or plurality of directions by drive systems (actuators) to change its position. The digital microscope is provided with an objective lens that forms an image of a specimen on the light receiving surface of the imaging element and an actuator that controls the inclination and height of the imaging element and the image plane of the objective lens to adjust the focus position. As the imaging element, a sensor having a plurality of pixels (light receivers) such as a line sensor or image sensor is used. The digital microscope may be provided with a plurality of imaging elements.

Every time a drive system such as the stage or an actuator performs driving, its movement involves a positional displacement (or positional error). Driving is performed basically every time a small image is captured. The drive systems perform driving in such a way that the positions of the imaging element and the stage are set to predetermined positions so that imaging is performed at a target imaging position. The positional displacement refers to a displacement of the actual imaging position from the target imaging position. The magnitude (or amount) of displacement of the stage is represented by a value stated in the catalogue or the product specification as the repeat accuracy. In some cases, the magnitude of positional displacement is represented by its magnitude on the light receiving surface of the imaging element. For example, when a point on the specimen is imaged at a point on the light receiving surface of the imaging element, a positional displacement of the stage and/or the actuator leads to a shift in the position of the point by a small distance on the light receiving surface. Hereinafter, the magnitude of positional displacement represented by the distance of shift on the light receiving surface of the imaging element will be referred to as the equivalent positional displacement on the light receiving surface of the imaging element.

The above-described digital microscope is provided with two or more drive systems with low accuracy, that is, drive systems of which the equivalent positional displacement on the light receiving surface of the imaging element is larger than the size of one pixel or of which the equivalent positional displacement on the light receiving surface of the imaging element is so large as to exceed an allowable limit below which a captured image can be displayed without any problem. According to the image combining method according to the present invention, small images captured by imaging are corrected by correcting a positional displacement caused by the drive systems with low accuracy and an image is composed by stitching small images thus corrected. The low accuracy drive systems may be equipped with a measuring device(s) that can measure the position containing a positional displacement of the stage or the actuator after driving. Such a measurement device includes a displacement gauge, a linear encoder, and a rotary encoder.

In the step of obtaining the position after driving according to the present invention, the position containing a positional displacement after driving is obtained when the low accuracy drive systems operate. The position after driving is obtained by performing measurement by the aforementioned measuring device and obtaining an estimated value of the position after driving using a table or function prepared beforehand. It is preferred that the position after driving with respect to all the directions of driving by the low accuracy drive systems be obtained using the measuring device(s) such as a sensor(s). Alternatively, the position after driving with respect to one or some directions of driving by the low accuracy drive systems is obtained using the measuring device(s) such as a sensor(s), and the position after driving with respect to the other directions of driving by the low accuracy drive systems be obtained by estimation. This can lead to a reduction in the number of measuring devices.

In the step of determining the amount of positional displacement/deformation according to the present invention, the amount of positional displacement/deformation of a small image is determined based on the position containing a positional displacement after driving obtained in the step of obtaining the position after driving. The position containing a positional displacement after driving is information about the position after driving representing the position with respect to at least one direction of the imaging element and/or the holding member after the driving by the drive systems. Models of computation of the amount of positional displacement/deformation include affine transformation, projective transformation, and affine transformation taking into account the effect of the distortion of the objective lens. The model to be used is determined by the construction of the digital microscope. The amount of positional displacement/deformation is estimated using only the position containing a positional displacement after driving or using the position containing a positional displacement after driving and other information in combination. The other information includes the position after driving of a drive system of which the positional displacement is so small as to make the influence of the image negligible. In the correction of a small image, deformation of the small image attributed to characteristics of an optical member(s) in the digital microscope may also be corrected.

The digital microscope according to the present invention has a plurality of drive systems, some of which cause a relatively large positional displacement. In common digital microscopes, the amount of displacement is estimated by estimating the similarity of adjoining small images in an overlapping area by computation. If the digital microscope has a large number of drive systems that cause a large positional displacement, a deformation of images will arise, leading to long computation time. In the present invention, since the position containing a positional displacement after driving is obtained in the step of obtaining the position after driving, the process of estimating the amount of deformation based on the image analysis can be obviated. Consequently, an overall image can be formed with reduced latency time.

In the step of determining the amount of positional displacement/deformation according to the present invention, the amount of positional displacement/deformation of a small image is estimated based on the position containing a positional displacement after driving obtained in the step of obtaining the position after driving and the similarity of adjoining small images in an overlapping area. The position containing a positional displacement after driving is information about the position after driving representing the position with respect to at least one direction of the imaging element and/or the holding member after the driving by the drive systems. The similarity of adjoining small images in an overlapping area refers to the similarity of images in an area in which adjoining small images overlap each other. Models of computation of the amount of positional displacement/deformation include affine transformation, projective transformation, and affine transformation taking into account the effect of distortion of the objective lens. The model to be used is determined by the construction of the digital microscope. The amount of positional displacement/deformation is estimated using the position containing a positional displacement after driving and the similarity of adjoining small images in an overlapping area or using other information additionally in combination with them. The other information includes the position after driving not containing a positional displacement. In the correction of a small image, deformation of the small image attributed to characteristics of optical members in the digital microscope may also be corrected.

The digital microscope according to the present invention has a plurality of drive systems, some of which cause a relatively large positional displacement. In common digital microscopes, the amount of displacement is estimated by estimating the similarity of adjoining small images in an overlapping area by computation. If the digital microscope has a large number of drive systems that cause a large positional displacement, deformation of images will arise, leading to long computation time. In the present invention, since the position containing a positional displacement after driving is obtained for one or some of the drive systems in the step of determining the amount of positional displacement/deformation, the search space of the amount of deformation can be made smaller, leading to a reduction in the time taken to estimate the amount of deformation.

### First Embodiment

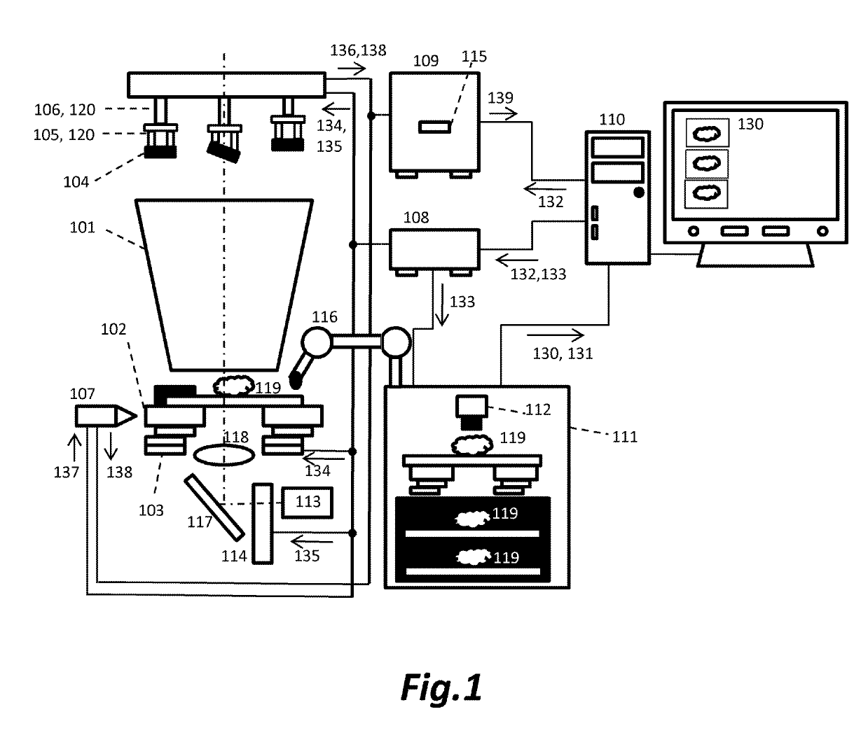

A first embodiment of the present invention will be described with reference to FIG. 1. The digital microscope according to the embodiment includes an objective lens 101, a specimen holding unit 102, a three-axis stage 103, an image sensor 104, a tilt angle control actuator 105, a depth control actuator 106, a displacement gauge 107, a control apparatus 108, an image processing apparatus 109, a computer 110, a specimen selection unit 111, a light source 113, and an electrically-driven filter wheel 114. The tilt angle control actuator 105 and the depth control actuator 106 each have a linear encoder 120 built therein. The image sensor 104, the angle control actuator 105, and the depth control actuator 106 constitute an imaging unit. There are P×Q imaging units arranged in an array, where P and Q are integers in the range of 2 to about 30, which are determined based on the number of pixels of the image sensor and the angle of field of the lens. The electrically-driven filter wheel 114 has S kinds of color filters provided therein. Normally, S is three, and the colors of the filters are red, green, and blue.

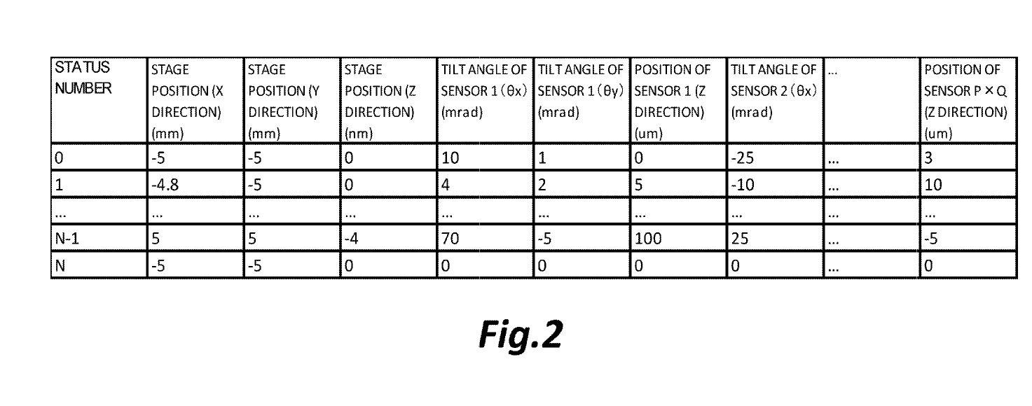

Now, the procedure of imaging with the digital microscope according to the present invention will be described. A user firstly inserts all of the specimens to be imaged into the specimen selection unit 111. After the insertion, thumbnail image data 130 of the specimens and surface shape data 131 of the specimens are acquired in the specimen selection unit 111 and transmitted to the computer 110. The surface shape data 131 of the specimens is information about the surface height measured at several points on the specimens by a range meter 112 provided in the specimen selection unit 111. The computer 110 converts the surface shape data 131 into a status table 132 of the three-axis stage 103, the tilt angle control actuator 105, and the depth control actuator 106. The status table 132 is a table in which the absolute positions (setting target values) of the three-axis stage 103, the tilt angle control actuator 105, and the depth control actuator 106 in the respective statuses starting with the initial status (denoted by status number 0) and ending with the final status (denoted by status number N) are stored. Here, N is the largest status number, which is equal to the number of times of image capturing. An example of the status table is shown in FIG. 2. The absolute positions are computed in such a way as to bring the surface of the specimen in focus in imaging performed in each of the statuses.

The user selects one of the thumbnail images 130 of the specimens in a GUI displayed on the display of the computer 110 using a mouse to designate the selection number of the specimen to be imaged. As a consequence, the status table 132 corresponding to the specimen selection number 133 is transmitted from the computer 110 to the control apparatus 108 and the image processing apparatus 109 and stored in their internal memories. The control apparatus 108 sends the specimen selection number 133 to the specimen selection unit 111, so that the specimen selection unit 111 brings the specimen corresponding to the specimen selection number 133 onto the specimen holding unit 102 and fixes it using a robot arm 116.

### <Process of Capturing Small Images>

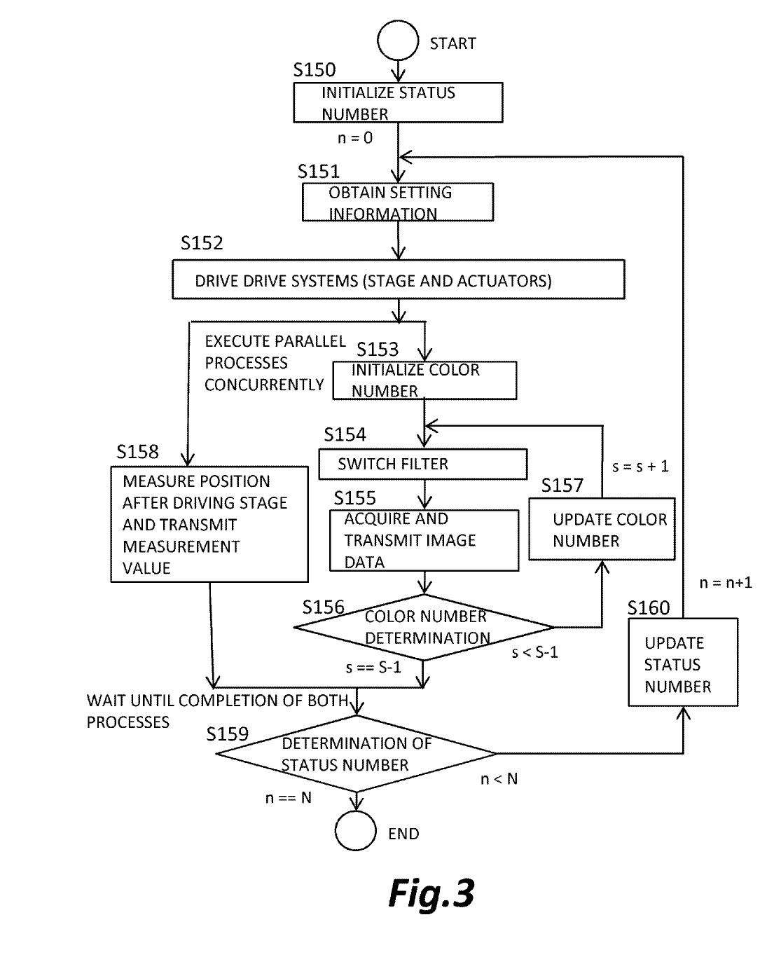

Then, the control apparatus 108 executes the process of acquiring small image data in accordance with the procedure shown in FIG. 3. Firstly, the control apparatus 108 initializes the status number (S150) and retrieves the setting information of the drive systems for the status number 0 from the status table 132 (S151). Then, the control apparatus 108 transmits drive control signals 134 to the three-axis stage 103, the tilt angle control actuator 105, and the depth control actuator 106 (S152).

Then, the control apparatus 108 initializes the color number (S153), and transmits an acquisition control signal 135 to the image sensor 104 and the electrically-driven filter wheel 114. The color numbers are identification numbers of the respective colors of the plurality of color filters held by the electrically-driven filter wheel 114. The electrically-driven filter wheel 114 is a part that holds a plurality of color filters for coloring white light emitted from the light source 113 and is selectively switches them. After the acquisition control signal 135 is transmitted, switching of the filter by the electrically-driven filter wheel 114 (S154) and acquisition of image data by the image sensor 104 (S155) are performed sequentially. The acquisition control signal 135 is transmitted a number of times equal to the number of colors (S156, S157). Every time the acquisition control signal is transmitted, small image data 136, the color of which is varied according to the acquisition signal, is acquired and transmitted to the image processing apparatus 109.

On the other hand, the control apparatus 108 transmits a measurement start signal 137 to the displacement gauge 107 and the linear encoder 120 (S158) simultaneously with the first transmission of the acquisition control signal 135. There are provided two displacement gauges 107 so that the shift of the three-axis stage 103 can be measured with respect to the x and y directions. Thus, position measurement values after driving 138 with respect to the x and y directions are obtained. Since the positional displacement with respect to the z direction is as small as 20 nm or smaller and does not affect the image, measurement by a measuring device is not performed with respect to the z direction. The linear encoders 120 are built in the tilt angle control actuator 105 and the depth control actuator 106 to measure the respective positions after driving. The linear encoder 120 is characterized by having an accuracy that enables accurate measurement of a positional displacement occurring after driving by the actuator, unlike with scales that common actuators are equipped with. The position measurement values after driving 138 obtained by the displacement gauge 107 and the linear encoder 120 are sent to the image processing apparatus 109.

The image processing apparatus 109 stores data 136 of small images of different colors and positions and the position measurement values after driving 138 in an internal memory 115.

Then, the control apparatus 108 updates the status number to 1 and obtains the setting information of the drive systems from the status table 132, which the control apparatus 108 has. The control apparatus 108 performs the setting of the drive systems and data acquisition in the same manner as with the case of status number 0 and stores small image data 136 and the position measurement values after driving 138 in an internal memory 115 of the image processing apparatus 109. The control apparatus 108 executes the same process repeatedly while incrementing the status number until it reaches N−1 (S159, n<N, S160).

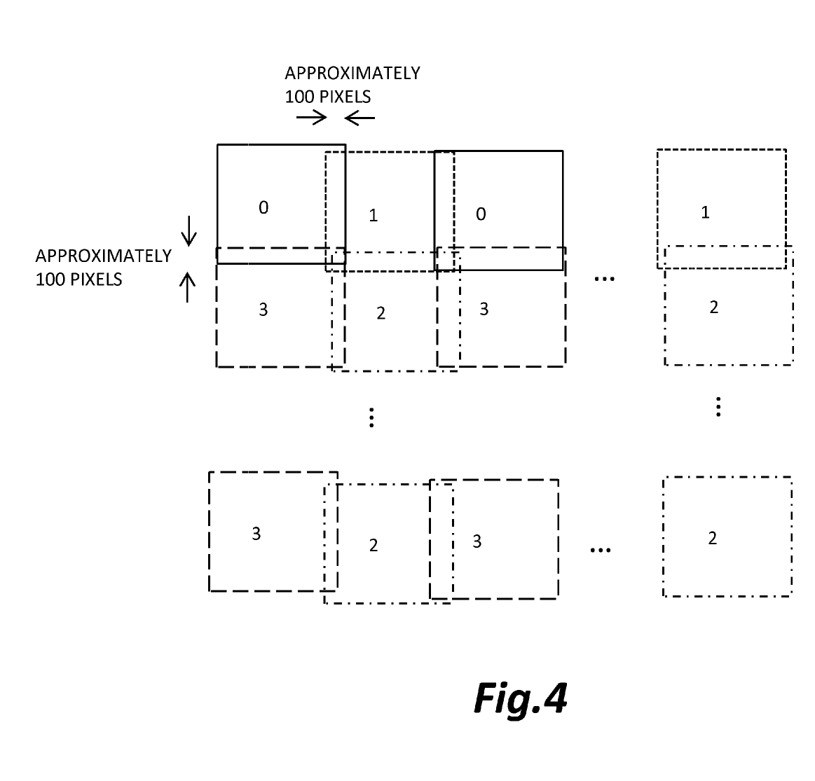

Exemplary positions of small images obtained by the data acquisition are shown in FIG. 4. The numbers attached to the small images are the status numbers at the time of the data acquisition. Adjoining of images has an overlapping area with a width of approximately 100 pixels. Although a tilt of the imaging element or other factors will cause a small positional displacement and deformation of small images, providing overlapping areas enables image capturing over a wide area without gaps between small images.

In the final status (denoted by status number N), the drive systems are initialized, and the small image data acquisition process is terminated (S159, n=N).

### <Image Processing>

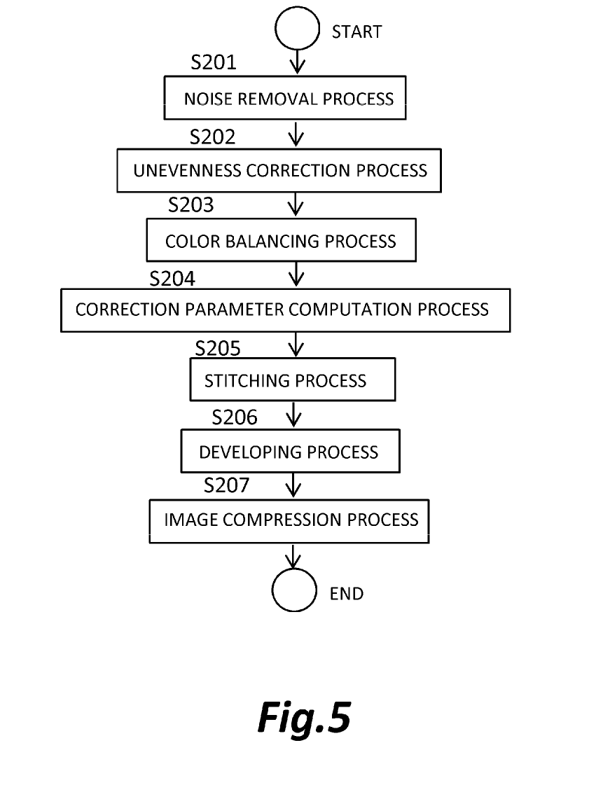

The image processing apparatus 109 performs image processing in accordance with the procedure shown in FIG. 5. The acquired small image data 136 is processed into monochromatic small image data 220 through a noise removal process (S201), unevenness correction process (S202), and color balancing process (S203). Since these processes are common processes, they will not be described. Pieces of monochromatic small image data 220 of different colors and of the same portion are combined into single piece of data. The data thus obtained will be referred to as color small image data 221.

Since all the pieces of monochromatic small image data 220 of which the color small image data 221 is composed are acquired by imaging performed in the same status (i.e. the status denoted by the same status number), they have the same positional displacement and deformation.

### <Correction Parameter Computation Process>

In a correction parameter computation process (S204), the image processing apparatus 109 computes parameters used in positional displacement/deformation correction processing to be applied to the color small image data 221. Positional displacement and deformation are handled together by a projective transformation represented by the following formula 1:

$${x}^{( k )} = \frac{{a}_{k} x + {b}_{k} y + {c}_{k}}{{g}_{k} x + {h}_{k} y + 1} , \\ {y}^{( k )} = \frac{{d}_{k} x + {e}_{k} y + {f}_{k}}{{g}_{k} x + {h}_{k} y + 1} . \qquad ( formula 1 ) ,$$

where x and y are coordinate values on the stitched overall image (i.e. coordinate values on the specimen), x^{(k)} and y^{(k)} are coordinate values on the k-th color small image, and aₖ, bₖ, cₖ, dₖ, eₖ, fₖ, gₖ, and hₖ are parameters of correction processing applied to the k-th color small image.

In the first embodiment, approximation of positional displacement and deformation is performed by a projective transformation. This is because the magnification by which the small image is magnified when imaged by the objective lens gently changes due to distortion. In the case where an objective lens with small enough distortion is used, the approximation may be performed by an affine transformation (i.e. a transformation in which the coefficients gₖ and hₖ in formula 1 are zero). This leads to a reduction in the computation time.

In calculating the correction processing parameters, the image processing apparatus 109 firstly computes coordinate values of n points on the overall image and n points on the color small image corresponding thereto in accordance with the function expressed by the following formula 2:

$$( \begin{matrix}x \\ y\end{matrix} ) = {T}_{ob} ( \begin{matrix}\begin{matrix}\begin{matrix}{T}_{le} \\ \end{matrix} \\ \end{matrix} \\ \end{matrix} \begin{matrix}( {T}_{im} ( \begin{matrix}{x}^{( k )} \\ {y}^{( k )} \\ {u}_{x} \\ {u}_{y} \\ {z}_{im}\end{matrix} ) ) \\ \begin{matrix}{t}_{x} \\ {t}_{y}\end{matrix} \\ {z}_{ob}\end{matrix} ) . \qquad ( formula 2 ) ,$$

where z_{ob} is the position after driving with respect to the z direction prescribed for the three-axis stage 103, uₓ and u_{y} are measurement values 138 of the position after driving of the tilt angle control actuator 105 obtained by the linear encoder 120, zᵢₘ is the measurement value 138 after driving of the depth control actuator 106 obtained by the linear encoder 120, and tₓ and t_{y} are measurement values 138 of the position after driving of the three-axis stage 103 measured by the displacement gauge 107. The number n of points to be selected is four or more. Typically, points near the four corners of the color small image are selected.

Function Tᵢₘ is a function providing parallel projection from the plane of the image sensor to the image plane of the objective lens. The image plane of the objective lens mentioned here is a plane intended to be the image plane according to the design of the objective lens, and it is different from the plane of the image sensor, which is controlled by the actuators. Function Tᵢₘ is expressed by the following formula:

$$( \begin{matrix}{x}^{′} \\ {y}^{′}\end{matrix} ) = {T}_{im} ( \begin{matrix}x \\ y \\ {u}_{x} \\ {u}_{y} \\ {z}_{im}\end{matrix} ) = ( \begin{matrix}{m}_{x} cos {θ}_{z} & - {m}_{y } sin {θ}_{z} \\ {m}_{x} sin {θ}_{z} & {m}_{y} cos {θ}_{z}\end{matrix} ) ( \begin{matrix}x \\ y\end{matrix} ) + ( \begin{matrix}{s}_{x} \\ {s}_{y}\end{matrix} ) , \qquad ( formula 3 ) ,$$

where θ_{z}, m_{z}, m_{y}, sₓ, and s_{y} are constants or functions having at least one of cos(uₓ), cos(u_{y}), and zᵢₘ as a variable. They represent the rotational angle (θ_{z}) of the plane of the image sensor, magnification (mₓ, m_{y}) changed by tilt, and translational shift (sₓ, s_{y}). It is necessary that θ_{z}, mₓ, m_{y}, sₓ, and s_{y} be so highly accurate that looseness in the operation of the tilt angle control actuator 105 and the depth control actuator 106 will matter (namely, that the average of the position after driving can be approximated by a function accurately). Various methods can be employed to improve the accuracy of the approximation. For example, an improvement can be achieved by providing a pin hole in the specimen holding unit 102, obtaining a plurality of positions of a bright point on the image plane while changing uₓ, u_{y}, and zᵢₘ, and performing function fitting using the obtained positions.

Function Tₗₑ provides transformation of the position from the image plane of the lens to the object plane. Function Tₗₑ is expressed by the following formula:

$$( \begin{matrix}{x}^{′} \\ {y}^{′}\end{matrix} ) = {T}_{le} ( \begin{matrix}x \\ y\end{matrix} ) = \frac{1}{β ( r )} \cdot ( \begin{matrix}x - {c}_{x} \\ y - {c}_{y}\end{matrix} ) + ( \begin{matrix}{c}_{{x}^{′}} \\ {c}_{{y}^{′}}\end{matrix} ) , \qquad ( formula 4 )$$

where cₓ and c_{y} represent the position of the optical axis on the image plane, c_{x′} and c_{y′} represent the position of the optical axis on the object plane, r is the distance between a point (x, y) and the optical axis on the image plane (i.e. the image height), and β(r) is a function expressing the lateral magnification at image height r, which is determined from the distortion characteristics of the objective lens as designed or as actually measured.

Function T_{ob} is a function providing parallel projection from the object plane of the objective lens to the plane of the specimen. Function T_{ob} is expressed by the following formula:

$$( \begin{matrix}{x}^{′} \\ {y}^{′}\end{matrix} ) = {T}_{ob} ( \begin{matrix}x \\ y \\ {t}_{x} \\ {t}_{y} \\ {z}_{ob}\end{matrix} ) = ( \begin{matrix}{m}_{x}^{′} cos {θ}_{z}^{′} & - {m}_{y }^{′} sin {θ}_{z}^{′} \\ {m}_{x}^{′} sin {θ}_{z}^{′} & {m}_{y}^{′} cos {θ}_{z}^{′}\end{matrix} ) ( \begin{matrix}x \\ y\end{matrix} ) + ( \begin{matrix}{s}_{x}^{′} \\ {s}_{y}^{′}\end{matrix} ) . \qquad ( formula 5 ) ,$$

where θ′_{z}, m′ₓ, m′_{y}, s′ₓ, and s′_{y} are constants or functions having at least one of tₓ, t_{y}, and z_{ob} as a variable. As is the case with function Tᵢₘ, θ′_{z}, m′ₓ, m′_{y}, s′ₓ and s′_{y} are so highly accurate that the function can approximate the average of the position after driving.

Then, the following simultaneous equations containing coordinate values xᵢ and yᵢ (i=1, 2, . . . , n) of the n points on the overall image which are obtained according to formula 2 and the coordinate values xᵢ^{(k)} and yᵢ^{(k)} (i=1, 2, . . . , n) of the n points on the k-th color small image are solved:

$$( \begin{matrix}{x}_{1} & {y}_{1} & 1 & 0 & 0 & 0 & - {x}_{1}^{( k )} {x}_{1} & - {x}_{1}^{( k )} {y}_{1} \\ 0 & 0 & 0 & {x}_{1} & {y}_{1} & 1 & - {y}_{1}^{( k )} {x}_{1} & - {y}_{1}^{( k )} {y}_{1} \\ {x}_{2} & {y}_{2} & 1 & 0 & 0 & 0 & - {x}_{2}^{( k )} {x}_{2} & - {x}_{2}^{( k )} {y}_{2} \\ 0 & 0 & 0 & {x}_{2} & {y}_{2} & 1 & - {y}_{2}^{( k )} {x}_{2} & - {y}_{2}^{( k )} {y}_{2} \\ & & & & & ⋮ & & \\ {x}_{n} & {y}_{n} & 1 & 0 & 0 & 0 & - {x}_{n}^{( k )} {x}_{n} & - {x}_{n}^{( k )} {y}_{n} \\ 0 & 0 & 0 & {x}_{n} & {y}_{n} & 1 & - {y}_{n}^{( k )} {x}_{n} & - {y}_{n}^{( k )} {y}_{n}\end{matrix} ) ( \begin{matrix}{a}_{k} \\ {b}_{k} \\ {c}_{k} \\ {d}_{k} \\ {e}_{k} \\ {f}_{k} \\ {g}_{k} \\ {h}_{k}\end{matrix} ) = ( \begin{matrix}{x}_{1}^{( k )} \\ {y}_{1}^{( k )} \\ {x}_{2}^{( k )} \\ {y}_{2}^{( k )} \\ ⋮ \\ {x}_{n}^{( k )} \\ {y}_{n}^{( k )}\end{matrix} ) . \qquad ( formula 6 ) .$$

The solutions (aₖ, bₖ, cₖ, dₖ, eₖ, fₖ, gₖ, and hₖ)^{T} of the simultaneous equations are correction processing parameters. The equations are solved by numerical calculation using QR decomposition or other methods.

Performing the same processing for all the color small image data gives correction processing parameters aₖ, bₖ, cₖ, dₖ, eₖ, fₖ, gₖ, and hₖ (k=1, 2, . . . , M), where M is the number of pieces of color small image data, which is equal to P×Q×N, P×Q being the number of imaging units, and N being the number of statuses.

### <Remaining Process in Image Processing>

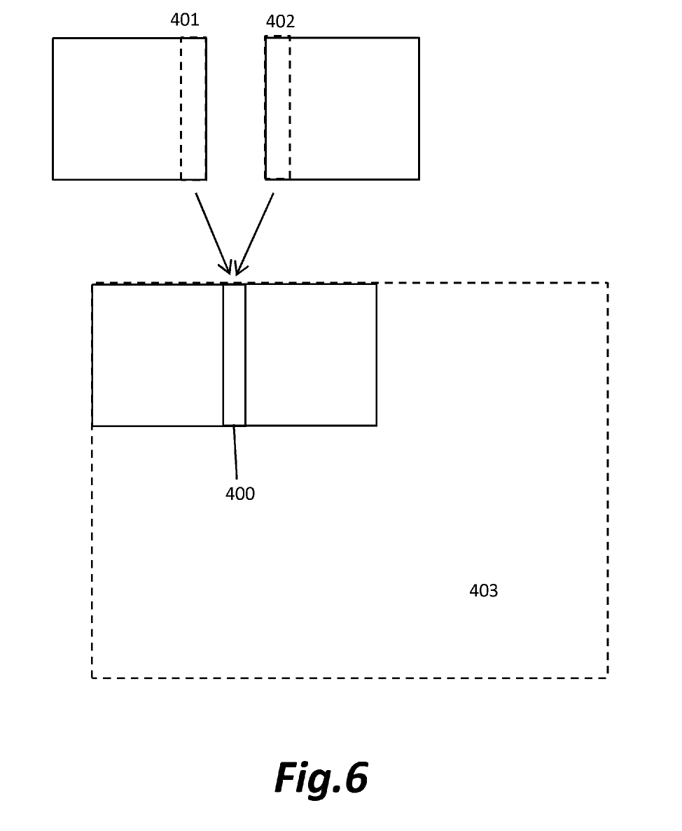

Here, remaining process steps in the image processing shown in FIG. 5 will be described. In stitching process (S205), the image processing apparatus 109 retrieves color small image data from the internal memory 115 in the image processing apparatus 109, executes correction processing for each monochromatic small image data it internally has, and generates a single overall image data. As will be seen from FIG. 6, in the overlapping area 400 in the overall image 403, two types of image data 401, 402 are computed based on adjoining small images respectively. In typical cases, a parting line is set at the center of the overlapping area, and the small image for which correction is performed is switched crossing the partition line. There may be adopted weighted averaging in which the value of each pixel is multiplied by a weight determined in accordance with its distance from the edge of the overlapping area (the left and right edges in the case shown in FIG. 6, or the upper and lower edges in the case of adjoining small images arranged one above the other) and the values thus weighted are averaged.

In the developing process (S206) and in the compression process (S207), commonly used methods are employed, and they will not be described specifically. For example, the image processing apparatus 109 performs color control so as to make the color space of the image an sRGB color space and performs JPEG compression. In consequence, compressed overall image data 139 is generated by the image processing apparatus 109.

The image processing apparatus 109 transmits the compressed overall image data 139 to the computer 110, which stores the compressed overall image data in a predetermined directory. After all the data has been transmitted, the computer 110 changes the reading status field of the GUI displayed on the display into “COMPLETED” and terminates the imaging process.

As described above, the digital microscope according to the first embodiment of the present invention is provided with a number of drive systems that drive the plurality of imaging elements and the stage and measures a positional displacement occurring after driving using the displacement gauge and the linear encoders. Since deformation and positional displacement of images are obtained based on measured values, estimative computation based on images is obviated. In consequence, latency time due to an image correction process can be made shorter.

### Second Embodiment

A second embodiment of the present invention will be described.

In bringing the surface of a specimen in focus, a digital microscope according to the second embodiment does not control the tilt of the imaging element itself or the position of the imaging element with respect to the optical axis direction but controls the tilt of an intermediate image formed by an objective lens using a mirror. The position after driving of the actuator that controls the tilt of the mirror and a displacement contained therein can be obtained by a rotary encoder attached to the mirror.

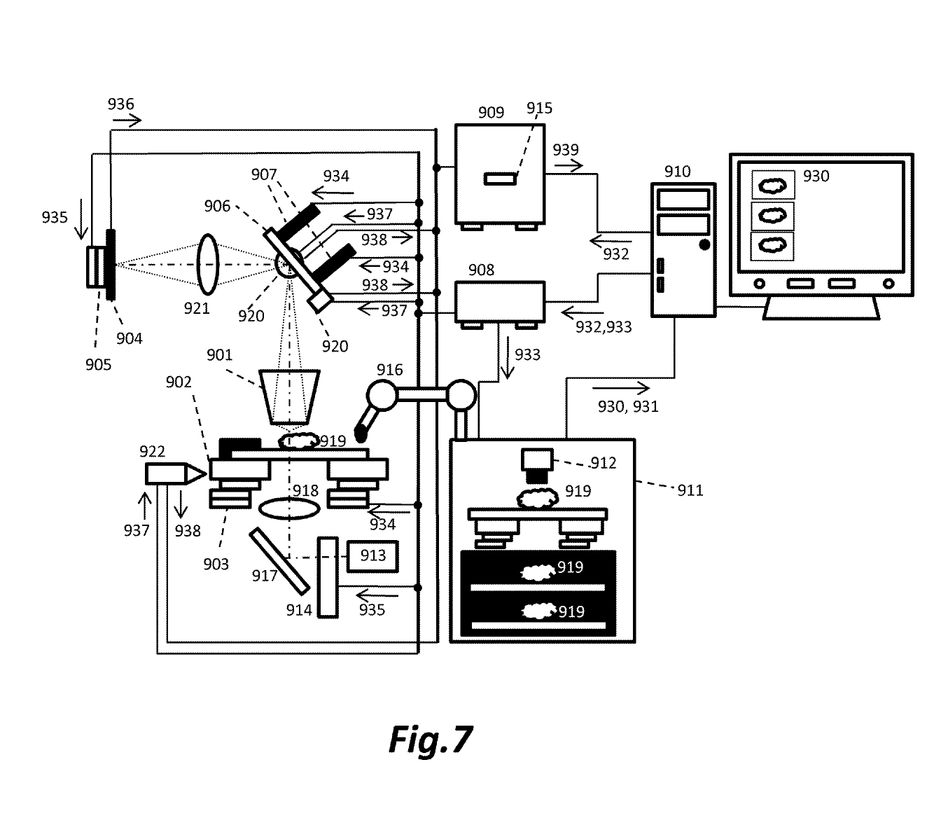

FIG. 7 shows the construction of the digital microscope according to the second embodiment. The microscope according to the second embodiment differs from the first embodiment, besides the aforementioned mirror, in that it uses a single line sensor and a stage for driving the sensor but does not have a plurality of image sensors. The imaging process is substantially the same as that in the first embodiment with the increased number of statuses and with the number of imaging elements being one. In the following, what is different from the first embodiment will be mainly described.

The digital microscope according to the second embodiment has a line sensor 904 instead of an image sensor. Two dimensional image data (or a small image) equivalent to that captured by an image sensor can be acquired by performing imaging at regular intervals while moving a line sensor driving stage 905 in a direction perpendicular to the direction along which the pixels of the line sensor 904 are arranged. The digital microscope has a mirror for focus adjustment 906, which is arranged in such a way as to be inclined relative to the image plane of the objective lens 901 by an angle of 45 degrees about the point of intersection of the optical axis and the image plane. Thus, the mirror can be tilted by a mirror orientation control actuator 907. There are two rotational axes of tilting (that is, x and y axes which are in the plane of the reflecting surface of the mirror and respectively parallel and perpendicular to the plane of the drawing sheet). The accuracy of the mirror orientation control actuator 907 is low, and positional displacement arises after driving. However, the rotational angle of the mirror can be measured accurately by a rotary encoder 920.

In the following, the procedure of imaging in the digital microscope according to the second embodiment will be described. The procedure from the start up to the capturing of small images is substantially the same as that in the first embodiment except that the operation of the tilt angle control actuator 105 in the first embodiment should be replaced by the operation of the mirror orientation control actuator 907. The motion achieved by the depth control actuator 106 can be achieved by the driving of a three-axis stage 903 in the z direction.

The procedure of image processing is also the same as that in FIG. 5, except that the process in the step of correction parameter computation (S2041) is different.

A formula used in positional displacement/deformation correction processing in the second embodiment is given below as formula 7, which is more simplified than formula 2.

$$( \begin{matrix}x \\ y\end{matrix} ) = {T}_{le} ( {T}_{im}^{′} ( \begin{matrix}{x}^{( k )} \\ {y}^{( k )} \\ {u}_{x} \\ {u}_{y}\end{matrix} ) ) + ( \begin{matrix}{t}_{x} \\ {t}_{y}\end{matrix} ) . \qquad ( Formula 7 ) ,$$

where uₓ and u_{y} are the tilt angles of the mirror 906 for focus adjustment, and tₓ and t_{y} are the positions after driving of the three-axis stage 903 with respect to the x and y directions respectively.

Function Tₗₑ expressed by formula 4 is a function representing distortion of the objective lens. Function T′ᵢₘ is the same as the function expressed by formula 3, but the dependency on the position with respect to the z direction is ignored (zᵢₘ=0 in formula 3) in function T′ᵢₘ. In the case where the tilt of the image plane is controlled by the mirror, the image plane is tilted by an angle equal to twice the angle of rotation of the mirror. Therefore, change of variables is also required for the tilt angles Uₓ and u_{y}. Formula 7 is so highly accurate that the function can approximate the average of the position after driving, as is the case in the first embodiment.

Correction processing parameters in formula 7 are uₓ, u_{y}, tₓ, and t_{y}. Since uₓ and u_{y} are output values of the rotary encoder 920, and tₓ and t_{y} are output values of the displacement gauge 922, the correction processing parameters will be uniquely determined.

The remaining steps in image processing and other processes such as transfer of image data to the computer 910 are the same as those in the first embodiment.

As described above, the digital microscope according to the second embodiment is provided with a number of drive systems for driving the line sensor and the stage. The positional displacement of the mirror for focus adjustment is measured by the rotary encoder, and the positional displacement of the stage is measured by the displacement gauge. With this feature, the digital microscope according to the second embodiment can achieve a reduction in the latency time due to an image stitching process.

### Third Embodiment

A third embodiment of the present invention will be described. The digital microscope according to the third embodiment has substantially the same construction as the first embodiment except that it is not equipped with a laser displacement gauge 107 and that it has a program for estimating the positional displacement of a three-axis stage provided in the image processing apparatus 109. A composing element equivalent to the composing element of the Embodiment 1 is denoted with the same symbol and name as the Embodiment 1 and its detailed description is omitted. The digital microscope according to the third embodiment is characterized in that the position after driving of the three-axis stage 103, which is determined by the laser displacement gauge 107 in the case of the first embodiment, is estimated by a program for estimating the positional displacement of the stage. In the following only the operation of the program for estimating the positional displacement of the stage will be described.

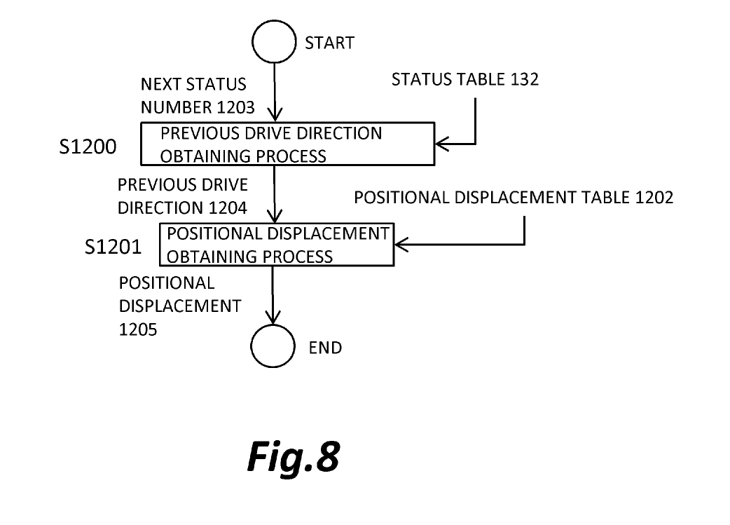

The process of the program for estimating the positional displacement of the stage will be described in the following with reference to FIG. 8. In a step of obtaining previous drive direction (S1200), the image processing apparatus 109 computes, based on the next status number 1203, the direction of driving of the stage on the last two occasions of driving with respect to each of the x and y axes. These values can be computed from the status table 132 stored in the internal memory 115 (memory unit) of the image processing apparatus 109. Although in the case where the next status number is 0 or 1, the drive direction on the last two occasions of driving cannot be obtained (because of the lack of two previous occasions of driving), the previous drive direction can be obtained by causing the stage to operate in a predetermined manner immediately after the start of imaging.

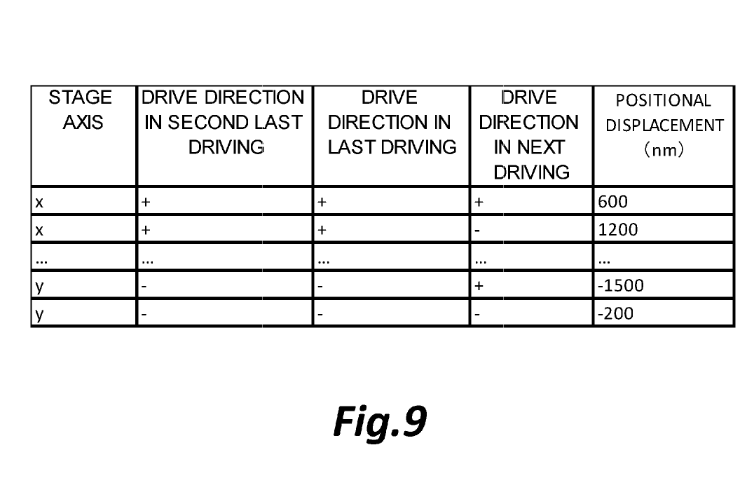

In a step of obtaining positional displacement (S1201), the positional displacement 1205 associated with the previous drive direction 1204 on the previous two occasions of driving (i.e. the last and second last occasions) obtained in the step of obtaining previous drive direction S1200 and the drive direction of the next (present) driving is obtained from a positional displacement table 1202. An example of the positional displacement table is shown in FIG. 9. In the positional displacement table 1202, the positional displacement in relation to the drive direction, which is obtained statistically, is stored in the form of a table. The positional displacement of the stage is caused by backlash (or looseness) of screws and gears used in the stage. Therefore, the positional displacement tends to become larger in the case where the drive direction is different from the last drive direction. In the statistical processing, the value (or amount) of positional displacement actually arises is firstly measured in various situations. Then, the measured values are sorted in groups in terms of the drive direction on the previous two occasions and the drive direction on the next occasion of driving. The measurement value can be obtained, for example, by providing a pin hole on the stage and determining the amount of shift of the pin hole in an image. The positional displacement amounts stored in the positional displacement table 1202 are average values of positional displacement in the respective sorted groups. In the exemplary case described as the third embodiment, the estimation is made based on information about the effect or influence of the drive direction on two previous occasions of driving on the position of the imaging element or the holding member after the next driving. However, the estimation may be made based on information about the drive direction on one or more than two previous occasions of driving.

As described above, the digital microscope according to the third embodiment of the present invention is provided with a number of drive systems, and the positional displacement is not measured by an expensive displacement gauge but is estimated by an estimation program. With this feature, the time taken by the image stitching process can be reduced in the digital microscope according to the third embodiment.

### Fourth Embodiment

In the following, a digital microscope according to a fourth embodiment of the present invention will be described. The fourth embodiment has many constituent parts that are same as those in the first embodiment, and FIGS. 1 to 4 referred to in the description of the first embodiment will be referred to in the following description of the fourth embodiment where necessary. It should be noted however that digital microscope according to the fourth embodiment does not have the linear encoder 120 illustrated in FIG. 1. Therefore, when FIG. 1 is referred to in the following description of the fourth embodiment, the linear encoder 120 should be considered to be absent. The digital microscope according to the fourth embodiment includes an objective lens 101, a specimen holding unit 102, a three-axis stage 103, an image sensor 104, a tilt angle control actuator 105, a depth control actuator 106, a displacement gauge 107, a control apparatus 108, an image processing apparatus 109, a computer 110, a specimen selection unit 111, a light source 113, and an electrically-driven filter wheel 114. The image sensor 104, the angle control actuator 105, and the depth control actuator 106 constitute an imaging unit. There are P×Q imaging units arranged in an array, where P and Q are integers in the range of 2 to about 30, which are determined based on the number of pixels of the image sensor and the angle of field of the lens. The electrically-driven filter wheel 114 has S kinds of color filters provided therein. Normally, S is three, and the colors of the filters are red, green, and blue.

Now, the procedure of imaging with the digital microscope according to the present invention will be described. A user firstly inserts all of the specimens to be imaged into the specimen selection unit 111. After the insertion, thumbnail image data 130 of the specimens and surface shape data 131 of the specimens are acquired in the specimen selection unit 111 and transmitted to the computer 110. The surface shape data 131 of the specimens is information about the surface height measured at several points on the specimens by a range meter 112 provided in the specimen selection unit 111. The computer 110 converts the surface shape data 131 into a status table 132 of the three-axis stage 103, the tilt angle control actuator 105, and the depth control actuator 106. The status table 132 is a table in which the absolute positions of the three-axis stage 103, the tilt angle control actuator 105, and the depth control actuator 106 in the respective statuses starting with the initial status (denoted by status number 0) and ending with the final status (denoted by status number N) are stored. Here, N is the largest status number, which is equal to the number of times of image capturing. An example of the status table is shown in FIG. 2. The absolute positions are computed in such a way as to bring the surface of the specimen in focus in imaging performed in each of the statuses.

The user selects one of the thumbnail images 130 of the specimens in a GUI displayed on the display of the computer 110 using a mouse to designate the selection number of the specimen to be imaged. As a consequence, the status table 132 corresponding to the specimen selection number 133 is transmitted from the computer 110 to the control apparatus 108 and the image processing apparatus 109 and stored in their internal memories. The control apparatus 108 sends the specimen selection number 133 to the specimen selection unit 111, so that the specimen selection unit 111 brings the specimen corresponding to the specimen selection number 133 onto the specimen holding unit 102 and fixes it using a robot arm 116.

### <Process of Capturing Small Images>

Then, the control apparatus 108 executes the process of acquiring small image data in accordance with the procedure shown in FIG. 3. Firstly, the control apparatus 108 initializes the status number (S150) and retrieves the setting information of the drive systems for the status number 0 from the status table 132 (S151). Then, the control apparatus 108 transmits drive control signals 134 to the three-axis stage 103, the tilt angle control actuator 105, and the depth control actuator 106 (S152).

After the operation of all the drive systems is completed, the control apparatus 108 initializes the color number (S153), and transmits an acquisition control signal 135 to the image sensor 104 and the electrically-driven filter wheel 114. The color numbers are identification numbers of the respective colors of the plurality of color filters held by the electrically-driven filter wheel 114. The electrically-driven filter wheel 114 is a part that holds a plurality of color filters for coloring white light emitted from the light source 113 and is selectively switches them. After the acquisition control signal 135 is transmitted, switching of the filter by the electrically-driven filter wheel 114 (S154) and acquisition of image data by the image sensor 104 (S155) are performed sequentially. The acquisition control signal 135 is transmitted a number of times equal to the number of colors (S156, S157). Every time the acquisition control signal is transmitted, small image data 136, the color of which is varied according to the acquisition signal, is acquired and transmitted to the image processing apparatus 109.

On the other hand, the control apparatus 108 transmits a measurement start signal 137 to the displacement gauge 107 simultaneously with the first transmission of the acquisition control signal 135. There are provided two displacement gauges 107 so that the shift of the three-axis stage 103 can be measured with respect to the x and y directions. The position measurement values after driving 138 with respect to the respective directions are sent to the image processing apparatus 109 (S158).

The image processing apparatus 109 stores data 136 of small images of different colors and positions and the position measurement values after driving 138 in an internal memory 115.

Then, the control apparatus 108 updates the status number to 1 and obtains the setting information of the drive systems from the status table 132, which the control apparatus 108 has. The control apparatus 108 performs the setting of the drive systems and data acquisition in the same manner as with the case of status number 0 and stores small image data 136 and the position measurement values after driving 138 in an internal memory 115 of the image processing apparatus 109. The control apparatus 108 executes the same process repeatedly while incrementing the status number until it reaches N−1 (S159, n<N, S160).

Exemplary positions of small images obtained by the data acquisition are shown in FIG. 4. The numbers attached to the small images are the status numbers at the time of the data acquisition. Adjoining of images has an overlapping area with a width of approximately 100 pixels. Although a tilt of the imaging element or other factors will cause a small positional displacement and deformation of small images, providing overlapping areas enables image capturing over a wide area without gaps between small images.

In the final status (denoted by status number N), the drive systems are initialized, and the small image data acquisition process is terminated (S159, n=N).

### <Image Processing>

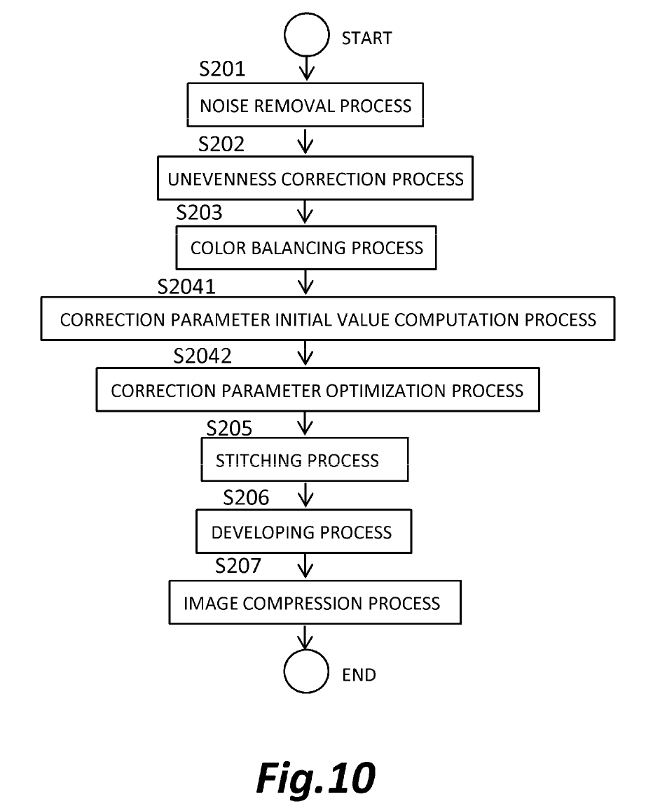

The image processing apparatus 109 performs image processing in accordance with the procedure shown in FIG. 10. In FIG. 10, the processing steps same as those in FIG. 5 are denoted by the same reference signs. The acquired small image data 136 is processed into monochromatic small image data 220 through a noise removal process (S201), unevenness correction process (S202), and color balancing process (S203). Since these processes are common processes, they will not be described. Pieces of monochromatic small image data 220 of different colors and of the same portion are combined into single piece of data. The data thus obtained will be referred to as color small image data 221.

Since all the pieces of monochromatic small image data 220 of which the color small image data 221 is composed are acquired by imaging performed in the status denoted by the same status number, they have the same positional displacement and deformation. The image processing apparatus 109 estimates parameters used in positional displacement/deformation correction processing for the color small image data 221 using monochromatic small image data of a specific color (typically, green). In the following, the monochromatic small image data used in estimation will be referred to as small image data for estimation 222.

### <Process of Computing Initial Values of Correction Parameters>

In the process of computing the initial values of correction parameters (S2041), the image processing apparatus 109 computes the initial values of the parameters used in positional displacement/deformation correction processing to be applied to the color small image data 221. Positional displacement and deformation are handled together by a projective transformation represented by the following formula 8:

$${x}^{( k )} = \frac{{a}_{k} x + {b}_{k} y + {c}_{k}}{{g}_{k} x + {h}_{k} y + 1} , \\ {y}^{( k )} = \frac{{d}_{k} x + {e}_{k} y + {f}_{k}}{{g}_{k} x + {h}_{k} y + 1} . \qquad ( formula 8 ) ,$$

where x and y are coordinate values on the stitched overall image (i.e. coordinate values on the specimen), x^{(k)} and y^{(k)} are coordinate values on the k-th color small image, and aₖ, bₖ, cₖ, dₖ, eₖ, fₖ, gₖ, and hₖ are parameters of correction processing applied to the k-th color small image.

In the fourth embodiment, approximation of positional displacement and deformation is performed by a projective transformation. This is because the magnification by which the small image is magnified when imaged by the objective lens gently changes due to distortion. In the case where an objective lens with small enough distortion is used, the approximation may be performed by an affine transformation (i.e. a transformation in which the coefficients gₖ and hₖ in formula 8 are zero). This leads to a reduction in the computation time.

In calculating the initial values of the correction processing parameters, the image processing apparatus 109 firstly computes coordinate values of n points on the overall image and n points on the color small image corresponding thereto in accordance with the function expressed by the following formula 9:

$$( \begin{matrix}x \\ y\end{matrix} ) = {T}_{ob} ( \begin{matrix}\begin{matrix}\begin{matrix}{T}_{le} \\ \end{matrix} \\ \end{matrix} \\ \end{matrix} \begin{matrix}( {T}_{im} ( \begin{matrix}{x}^{( k )} \\ {y}^{( k )} \\ {u}_{x} \\ {u}_{y} \\ {z}_{im}\end{matrix} ) ) \\ \begin{matrix}{t}_{x} \\ {t}_{y}\end{matrix} \\ {z}_{ob}\end{matrix} ) . \qquad ( formula 9 ) ,$$

where z_{ob} is the position after driving with respect to the z direction prescribed for the three-axis stage 103, uₓ and u_{y} are the tilt angles about the x and y axes after driving prescribed for the tilt angle control actuator 105, zᵢₘ is the position after driving with respect to the z direction of the image sensor prescribed for the depth control actuator 106, and tₓ and t_{y} are measurement values 138 of the position after driving of the three-axis stage 103 measured by the displacement gauge 107. The values of z_{ob}, uₓ, u_{y}, and zᵢₘ can be obtained from the status table 132. The number n of points to be selected is four or more. Typically, points near the four corners of the color small image are selected.

Function Tᵢₘ is a function providing parallel projection from the plane of the image sensor to the image plane of the objective lens. The image plane of the objective lens mentioned here is a plane intended to be the image plane according to the design of the objective lens, and it is different from the plane of the image sensor, which is controlled by the actuators. Function Tᵢₘ is expressed by the following formula:

$$( \begin{matrix}{x}^{′} \\ {y}^{′}\end{matrix} ) = {T}_{im} ( \begin{matrix}x \\ y \\ {u}_{x} \\ {u}_{y} \\ {z}_{im}\end{matrix} ) = ( \begin{matrix}{m}_{x} cos {θ}_{z} & - {m}_{y } sin {θ}_{z} \\ {m}_{x} sin {θ}_{z} & {m}_{y} cos {θ}_{z}\end{matrix} ) ( \begin{matrix}x \\ y\end{matrix} ) + ( \begin{matrix}{s}_{x} \\ {s}_{y}\end{matrix} ) , \qquad ( formula 10 ) ,$$

where θ_{z}, m_{z}, m_{y}, sₓ, and s_{y} are constants or functions having at least one of cos(uₓ), cos(u_{y}), and zᵢₘ as a variable. They represent the rotational angle (θ_{z}) of the plane of the image sensor, magnification (mₓ, m_{y}) changed by tilt, and translational shift (sₓ, s_{y}). It is necessary that θ_{z}, mₓ, m_{y}, sₓ, and s_{y} be so highly accurate that looseness in the operation of the tilt angle control actuator 105 and the depth control actuator 106 will matter (namely, that the function can accurately approximate the average of the position after driving). Various methods can be employed to improve the accuracy of the approximation. For example, an improvement can be achieved by providing a pin hole in the specimen holding unit 102, obtaining a plurality of positions of a bright point on the image plane while changing uₓ, u_{y}, and zᵢₘ, and performing function fitting using the obtained positions.

Function Tₗₑ provides transformation of the position from the image plane of the lens to the object plane. Function Tₗₑ is expressed by the following formula:

$$( \begin{matrix}{x}^{′} \\ {y}^{′}\end{matrix} ) = {T}_{le} ( \begin{matrix}x \\ y\end{matrix} ) = \frac{1}{β ( r )} \cdot ( \begin{matrix}x - {c}_{x} \\ y - {c}_{y}\end{matrix} ) + ( \begin{matrix}{c}_{{x}^{′}} \\ {c}_{{y}^{′}}\end{matrix} ) , \qquad ( formula 11 )$$

where cₓ and c_{y} represent the position of the optical axis on the image plane, c_{x′} and c_{y′} represent the position of the optical axis on the object plane, r is the distance between a point (x, y) and the optical axis on the image plane (i.e. the image height), and β(r) is a function expressing the lateral magnification at image height r, which is determined from the distortion characteristics of the objective lens as designed or as actually measured.

Function T_{ob} is a function providing parallel projection from the object plane of the objective lens to the plane of the specimen. Function T_{Ob} is expressed by the following formula:

$$( \begin{matrix}{x}^{′} \\ {y}^{′}\end{matrix} ) = {T}_{ob} ( \begin{matrix}x \\ y \\ {t}_{x} \\ {t}_{y} \\ {z}_{ob}\end{matrix} ) = ( \begin{matrix}{m}_{x}^{′} cos {θ}_{z}^{′} & - {m}_{y }^{′} sin {θ}_{z}^{′} \\ {m}_{x}^{′} sin {θ}_{z}^{′} & {m}_{y}^{′} cos {θ}_{z}^{′}\end{matrix} ) ( \begin{matrix}x \\ y\end{matrix} ) + ( \begin{matrix}{s}_{x}^{′} \\ {s}_{y}^{′}\end{matrix} ) . \qquad ( formula 12 ) ,$$

where θ′_{z}, m′ₓ, s′ₓ, and s′_{y} are constants or functions having at least one of tₓ, t_{y}, and z_{ob} as a variable. As is the case with function Tᵢₘ, θ′_{z}, m′ₓ, m′_{y}, s′ₓ, and s′_{y} are so highly accurate that the function can approximate the average of the position after driving.

Then, the following simultaneous equations containing coordinate values xᵢ and yᵢ (i=1, 2, . . . , n) of the n points on the overall image which are obtained according to formula 9 and the coordinate values xᵢ^{(k)} and yᵢ^{(k)} (i=1, 2, . . . , n) of the n points on the k-th color small image are solved:

$$( \begin{matrix}{x}_{1} & {y}_{1} & 1 & 0 & 0 & 0 & - {x}_{1}^{( k )} {x}_{1} & - {x}_{1}^{( k )} {y}_{1} \\ 0 & 0 & 0 & {x}_{1} & {y}_{1} & 1 & - {y}_{1}^{( k )} {x}_{1} & - {y}_{1}^{( k )} {y}_{1} \\ {x}_{2} & {y}_{2} & 1 & 0 & 0 & 0 & - {x}_{2}^{( k )} {x}_{2} & - {x}_{2}^{( k )} {y}_{2} \\ 0 & 0 & 0 & {x}_{2} & {y}_{2} & 1 & - {y}_{2}^{( k )} {x}_{2} & - {y}_{2}^{( k )} {y}_{2} \\ & & & & & ⋮ & & \\ {x}_{n} & {y}_{n} & 1 & 0 & 0 & 0 & - {x}_{n}^{( k )} {x}_{n} & - {x}_{n}^{( k )} {y}_{n} \\ 0 & 0 & 0 & {x}_{n} & {y}_{n} & 1 & - {y}_{n}^{( k )} {x}_{n} & - {y}_{n}^{( k )} {y}_{n}\end{matrix} ) ( \begin{matrix}{a}_{k} \\ {b}_{k} \\ {c}_{k} \\ {d}_{k} \\ {e}_{k} \\ {f}_{k} \\ {g}_{k} \\ {h}_{k}\end{matrix} ) = ( \begin{matrix}{x}_{1}^{( k )} \\ {y}_{1}^{( k )} \\ {x}_{2}^{( k )} \\ {y}_{2}^{( k )} \\ ⋮ \\ {x}_{n}^{( k )} \\ {y}_{n}^{( k )}\end{matrix} ) . \qquad ( formula 13 ) .$$

The solutions (aₖ, bₖ, cₖ, dₖ, eₖ, fₖ, gₖ, and hₖ)^{T} of the simultaneous equations are the initial values of the correction processing parameters. The equations are solved by numerical calculation using QR decomposition or other methods.

Performing the computation of the initial values for all the color small image data gives the initial values aₖ, bₖ, cₖ, dₖ, eₖ, fₖ, gₖ, and hₖ (k=1, 2, . . . , M) of the correction processing parameters, where M is the number of pieces of color small image data, which is equal to P×Q×N, P×Q being the number of imaging units, and N being the number of statuses.

### <Correction Parameter Optimization Process>

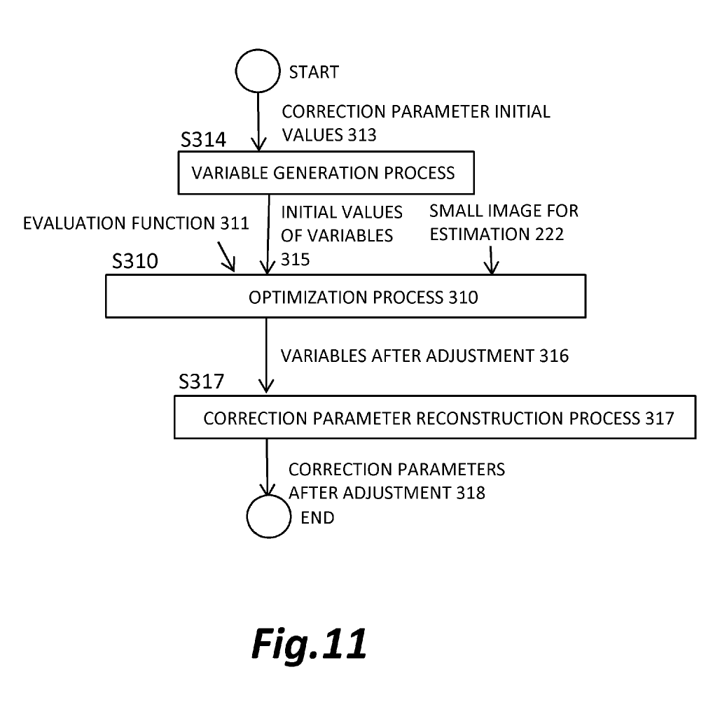

Then, in the correction parameter optimization process (S2042), the image processing apparatus 109 finely adjusts the correction parameters using optimization processing. The procedure of the correction parameter optimization process (S2042) will be described with reference to FIG. 11. The correction parameter optimization process (S2042) includes a variable generation process (S314), an optimization process (S310), and a correction parameter reconstruction process (S317). The optimization process (S310) is a process of searching for values of variables minimizing an evaluation function 311. No limitation is placed on the method used in the optimization process (S310), and a common simplex method disclosed in non-patent document 2 is used in the fourth embodiment.

The initial values 313 of the correction parameters obtained by the process of computing the initial values of correction parameters (S2041) are converted into initial values 315 of variables by variable generation process (S314). In cases where values highly accurately representing the positional displacement can be obtained by measurement, as is the case with the fourth embodiment, it is not necessary to adjust all of the correction parameters. In the variable generation process (S314), parameters for which adjustment need not be made are eliminated from the optimizing variables, or processing of normalizing one or some of the variables to make the adjustment steps finer is performed. In the fourth embodiment, the position after driving of the three-axis stage 103 with respect to the x and y directions are determined accurately by the laser displacement gauge 107, and the displacement with respect to the x and y directions caused by the tilt angle control actuator 105 are small. Therefore, the parameters (cₖ, fₖ) concerning the translational shift can be eliminated from the variations. A reduction in the number of variables leads to a reduction in the number of dimensions of the variable space and leads to a reduction in the computation time.

In the optimization process (S310), the image processing apparatus 109 adjusts the variables by a simplex method so as to enable minimization of the evaluation function 311. The evaluation function 311 will be described. Firstly, the image processing apparatus 109 retrieves the small image data for estimation 222 from the internal memory 115 of the image processing apparatus 109 and performs computing of a pixel block 300 from the small image data for estimation 222 and the correction parameters reconstructed from the variables.

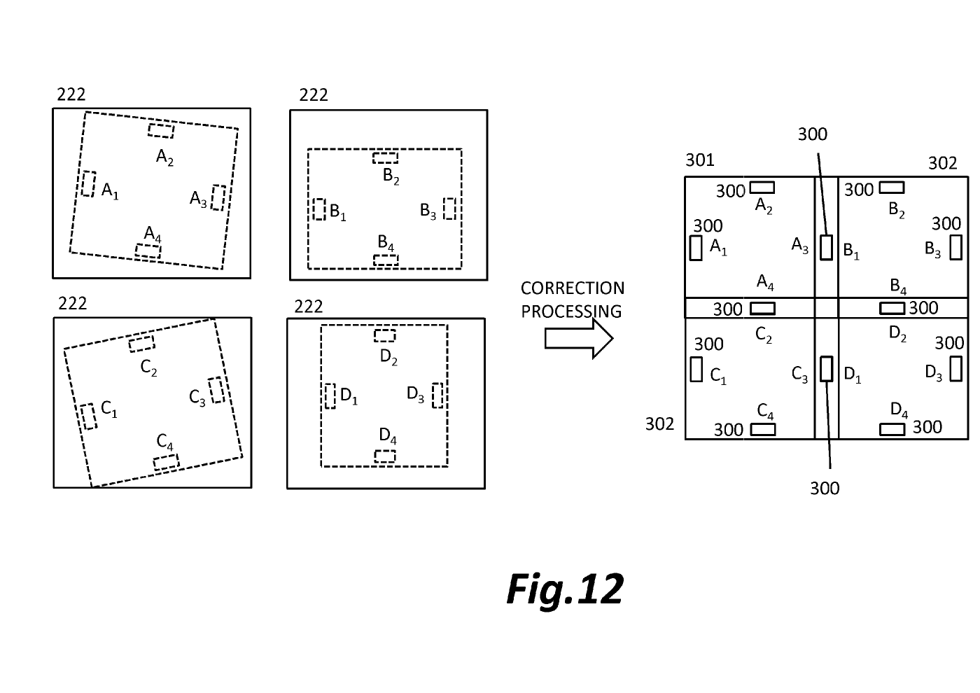

Here, the relationship between the pixel block 300 and the small image data for estimation 222 will be described with reference to FIG. 12. The pixel block 300 is a rectangular region in a small image after correction 301 obtained by correcting the small image for estimation 222 by a projective transformation. The small image after correction 301 overlaps an adjoining small image after correction 302 by a certain width. The pixel block 300 is generated in the overlapping area, and a pixel block is also generated from the adjoining small image after correction at the same position. The pixel bock 300 may be generated at any selected position in the overlapping area, though it is necessary that some pattern or figure exist in that pixel block.

After obtaining the pixel block 300 from each small image data for estimation 222, the image processing apparatus 109 computes an evaluation value in accordance with the following equation:

$${\sum }_{( i , j ) ∈ V} {\sum }_{x ∈ X} {( {f}_{i , x} - {f}_{j , x} )}^{2} . \qquad ( formula 14 ) ,$$

where V is a set of pairs of the numbers of the pixel blocks at the same position generated from different small image data for estimation, X is a set of the pixel numbers in the pixel block 300, and f_{i,x} is the value of the x-th pixel in the i-th pixel block. In an exemplary case shown in FIG. 12, numbers A₁, A₂, . . . , D₃, D₄ are allotted to the pixel blocks, and number pairs like (A₃, B₁) and (A₄, C₂) etc. are elements of V.

The sum of squares of the differences between the pixel values for all the pixel block pairs are calculated by formula 14. If correction is successful, this value will become zero. Therefore, the quality of correction can be evaluated by this value.

Variables after adjustment 316 adjusted by the optimization process (S310) are converted by correction parameter reconstruction process (S317) into correction parameters after adjustment 318, which are output as output values of the correction parameter optimization process 205.

### <Remaining Process in Image Processing>

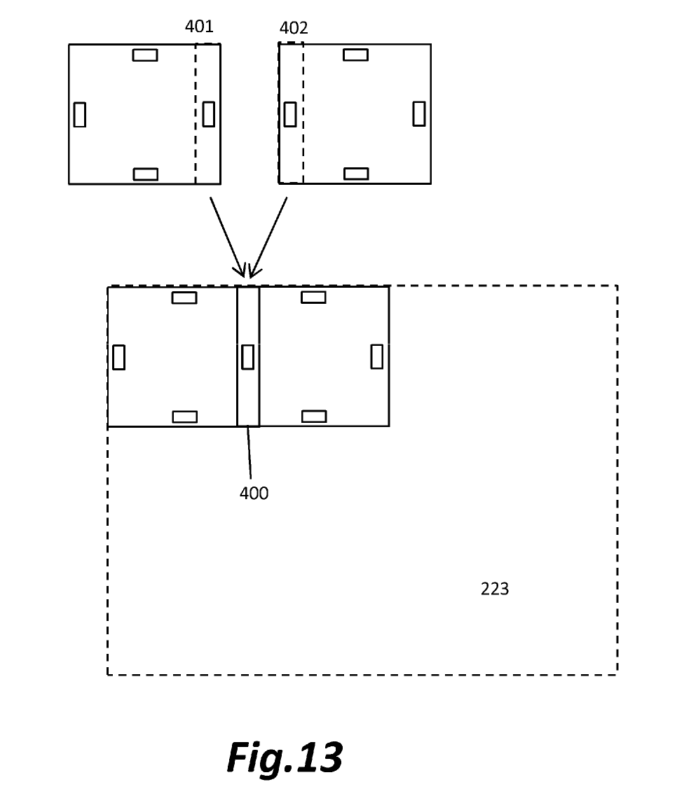

Here, remaining process steps in the image processing shown in FIG. 10 will be described. In stitching process (S205), the image processing apparatus 109 retrieves color small image data 221 from the internal memory 115 in the image processing apparatus 109, executes correction processing for each monochromatic small image data 220 it internally has, and generates a single overall image data 223. As will be seen from FIG. 13, in the overlapping area 400 in the overall image 223, two types of image data 401, 402 are computed based on adjoining small images respectively. In typical cases, a parting line is set at the center of the overlapping area, and the small image for which correction is performed is switched crossing the partition line. There may be adopted a weighted averaging in which the value of each pixel is multiplied by a weight determined in accordance with its distance from the edge of the overlapping area (the left and right edges in the case shown in FIG. 13, or the upper and lower edges in the case of adjoining small images arranged one above the other) and the values thus weighted are averaged.

In the developing process (S206) and in the compression process (S207), commonly used methods are employed, and they will not be described specifically. For example, the image processing apparatus 109 performs color control so as to make the color space of the image an sRGB color space and performs JPEG compression. In consequence, compressed overall image data 139 is generated by the image processing apparatus 109.

The image processing apparatus 109 transmits the compressed overall image data 139 to the computer 110, which stores the compressed overall image data in a predetermined directory. After all the data has been transmitted, the computer 110 changes the reading status field of the GUI displayed on the display into “COMPLETED” and terminates the imaging process.

As described above, the digital microscope according to the fourth embodiment of the present invention is provided with a number of drive systems that drive the plurality of imaging elements and the stage. The digital microscope measures the positional displacement of the stage using the displacement gauge, thereby reducing the time taken by the image stitching process.

### Fifth Embodiment

In the following, a fifth embodiment of the present invention will be described.

The fifth embodiment is characterized in that the position after driving of an actuator that controls the tilt of a mirror is obtained by a rotary encoder attached to the mirror to reduce the degree of freedom of correction parameters.

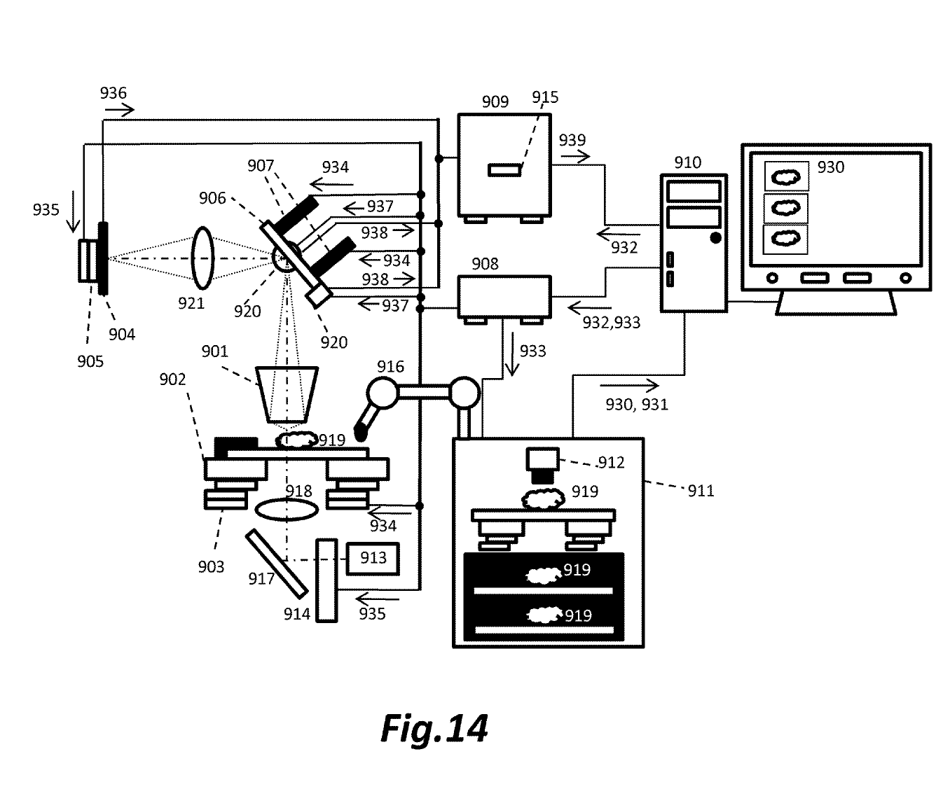

The construction of the digital microscope shown in FIG. 14 is similar to that according to the fourth embodiment but differs from it in that the digital microscope shown in FIG. 14 uses a single line sensor and a stage for driving the sensor but does not have a plurality of image sensors. In bringing the surface of a specimen in focus, the digital microscope shown in FIG. 14 does not control the tilt of the imaging element itself or the position of the imaging element with respect to the optical axis direction but controls the tilt of an intermediate image formed by an objective lens using a mirror. This digital microscope differs from that according to the fourth embodiment in that distortion greatly affects deformation of small images in this digital microscope.

Common processing is substantially the same as that in the fourth embodiment with the increased number of statuses and with the number of imaging elements being one. In the following, what is different from the fourth embodiment will be mainly described.

The digital microscope according to the fifth embodiment has a line sensor 904 instead of an image sensor. Two dimensional image data (or a small image) equivalent to that captured by an image sensor can be acquired by performing imaging at regular intervals while moving a line sensor driving stage 905 in a direction perpendicular to the direction along which the pixels of the line sensor 904 are arranged. The digital microscope has a mirror for focus adjustment 906, which is arranged in such a way as to be inclined relative to the image plane of the objective lens 901 by an angle of 45 degrees about the point of intersection of the optical axis and the image plane. Thus, the image can be tilted by a mirror orientation control actuator 907. There are two rotational axes of tilting (that is, x and y axes which are in the plane of the reflecting surface of the mirror and respectively parallel and perpendicular to the plane of the drawing sheet). The accuracy of the mirror orientation control actuator 907 is low, and a positional displacement arises after driving. However, the rotational angle of the mirror can be measured accurately by a rotary encoder 920.

In the following, the procedure of imaging in the digital microscope according to the fifth embodiment will be described. The procedure from the start up to the capturing of small images is substantially the same as that in the fourth embodiment except that the operation of the tilt angle control actuator 105 in the fourth embodiment should be replaced by the operation of the mirror orientation control actuator 907. The motion achieved by the depth control actuator 106 can be achieved by the driving a three-axis stage 903 in the z direction. Furthermore, the measurement of the position after driving of the stage by the displacement gauge 107 should be replaced by the measurement of the rotational angle of the mirror by the rotary encoder 920.

The procedure of image processing is also the same as that in FIG. 10, except that the process of computing the initial values of correction parameters (S2041) and the correction parameter optimization process (S2042) are different.

A formula used in positional displacement/deformation correction processing in the fifth embodiment is given below as formula 15, which is more simplified than formula 9.

$$( \begin{matrix}x \\ y\end{matrix} ) = {T}_{le} ( {T}_{im}^{′} ( \begin{matrix}{x}^{( k )} \\ {y}^{( k )} \\ {u}_{x} \\ {u}_{y}\end{matrix} ) ) + ( \begin{matrix}{t}_{x} \\ {t}_{y}\end{matrix} ) . \qquad ( Formula 15 ) ,$$

where uₓ and u_{y} are the tilt angles of the mirror 906 for focus adjustment, and tₓ and t_{y} are the positions after driving of the three-axis stage 903 with respect to the x and y directions respectively.

Function Tₗₑ expressed by formula 11 is a function representing distortion of the objective lens. Function T′ᵢₘ is the same as the function expressed by formula 10, but the dependency on the position with respect to the z direction is ignored (zᵢₘ=0 in formula 10) in function T′ᵢₘ. In the case where the tilt of the image plane is controlled by the mirror, the image plane is tilted by an angle equal to twice the angle of rotation of the mirror. Therefore, change of variables is also required for the tilt angles Uₓ and u_{y}. Formula 15 is so highly accurate that the function can approximate the average of the position after driving, as is the case in the fourth embodiment.

Correction processing parameters in formula 15 are uₓ, u_{y}, tₓ, and t_{y}. The initial values of uₓ and u_{y} are set to be equal to the output values of the rotary encoder 920, and the initial values of tₓ and t_{y} are set to 0. Since the output values of the rotary encoder 920 contain the influence of a positional displacement occurring after driving of the mirror orientation control actuator 907, adjustment of parameters uₓ and u_{y} need not be performed. In consequence, the parameters to be adjusted are only tₓ and t_{y}. This reduction in the number of parameters leads to a great reduction in the computation time.

In the correction parameter optimization process (S2042), a block matching method is used instead of the optimization method in the fourth embodiment. The block matching is a method of determining positional displacement by exhaustive search, as described in non-patent document 1.

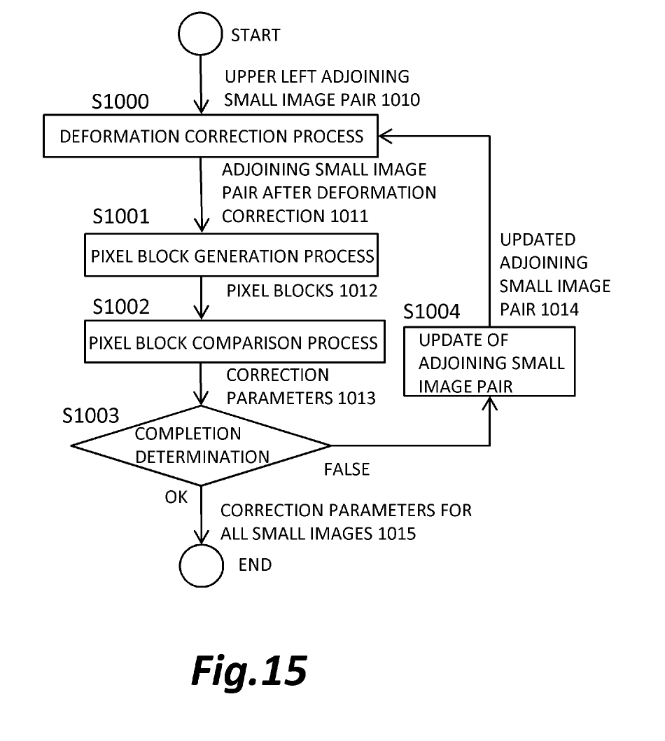

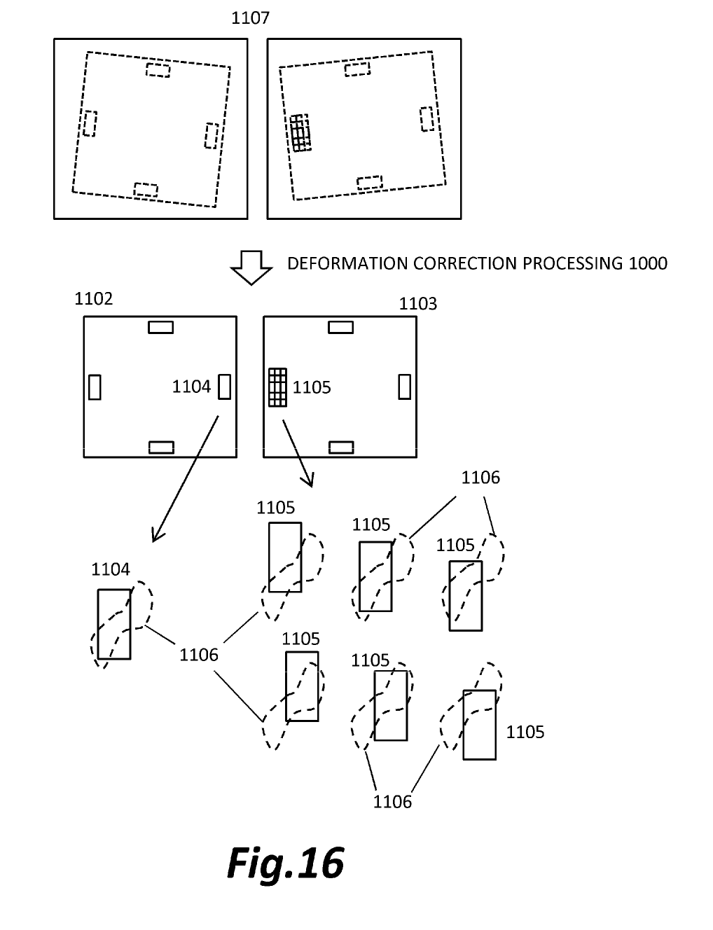

The procedure of block matching in the fifth embodiment is shown in FIG. 15. Firstly, the image processing apparatus 909 selects a pair of adjoining small images located at upper left and corrects distortion of these two images and magnification variation caused by a tilt of the mirror for focus adjustment 906 in a deformation correction process (S1000). This process is expressed by the first term in the right side of formula 15. In this process, the positional displacement is not corrected. In this process, correction need not necessarily be performed over the entire area of the small image, but it is sufficient to apply the correction only to the area overlapping an adjoining image. Then, in a pixel block generation process (S1001), the image processing apparatus 909 extracts a plurality of pixel blocks with small positional differences from a small image after correction. The pixel block mentioned herein is a small region in the overlapping area of adjoining images in which some pattern or figure is present (i.e. which is not completely uniform as an image), as is the case with the pixel block in the fourth embodiment. The positional relationship of pixel blocks and small images is shown in FIG. 16. While one pixel block 1104 is extracted from the left small image after deformation correction 1102, a plurality of pixel blocks 1105 of different positions are extracted from the right small image after deformation correction 1103. The small image from which a plurality of pixel blocks are extracted may be the left small image, as will be readily understood. In FIG. 16, what is depicted by the broken lines denoted by reference numeral 1106 is a figure present near the pixel blocks.

In the pixel block comparison process (S1002), the image processing apparatus 909 computes the evaluation function with the pixel block in the left small image and each of the pixel blocks in the right small image and selects the pixel block in the right small image with which the best evaluation is achieved. The evaluation value may be one commonly used in switching processing. Here, the SSD (sum of squared difference) described in non-patent document 1 is used in the evaluation. As a consequence, the values of the positional displacement of the thus selected block are set as correction parameters tₓ, t_{y}.

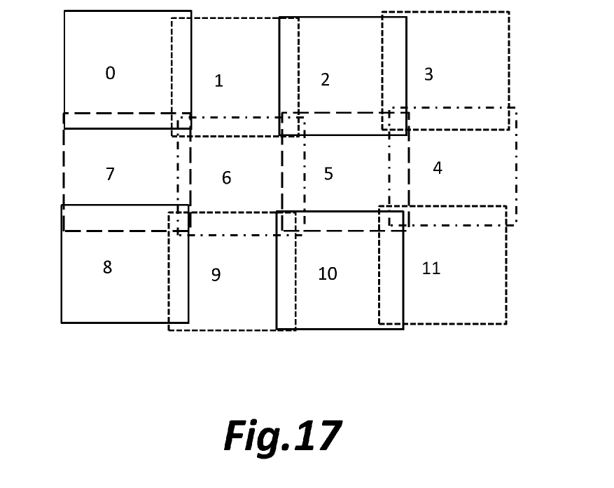

After setting the correction parameters tₓ, t_{y} for the adjoining small image pair at upper left, the image processing apparatus 909 updates the adjoining small image pair (S1004), and obtains correction parameters for the updated adjoining small image pair in the same way. The order of choosing adjoining small image pairs may be arbitrary, though it is necessary that correction parameters be obtained for every small image. FIG. 17 shows an exemplary order of choosing small images, where the order is represented by numbers N. In FIG. 17, two small images represented by numbers (N, N+1) (N=1, 2, . . . , 10) may be paired. This pairing is efficient for computation, because it allows computation of correction parameters during the time when the stage is moving. In the case where small images located one above the other like small image pairs (3, 4) and (7, 8) are paired, the right and left small images in the above description should be replaced by the upper and lower small images in setting correction parameters. In the termination determination (S1013), the image processing apparatus 909 verifies that correction parameters are computed for all the small image pairs, and terminates all the processing of block matching. Thus, correction parameters for all the small images are obtained as a result.

The remaining steps in image processing and other processes such as transfer of image data to the computer 910 are the same as those in the fourth embodiment.

As described above, the digital microscope according to the fifth embodiment of the present invention is provided with a number of drive systems for driving the line sensor and the stage. The positional displacement of the mirror for focus adjustment is measured by the rotary encoder. With this feature, the time taken by the image stitching process can be reduced in the digital microscope according to the fifth embodiment.

### Sixth Embodiment

The sixth embodiment of the present invention will be described.

In a digital microscope according to the sixth embodiment, the image stitching process, which is executed in the image processing apparatus 109 as a component of the digital microscope in the case of the first embodiment, is performed in the computer 110. Executing the image stitching process in the computer 110 having a high capacity memory and capable of high speed processing enables high-speed and highly-accurate stitching.

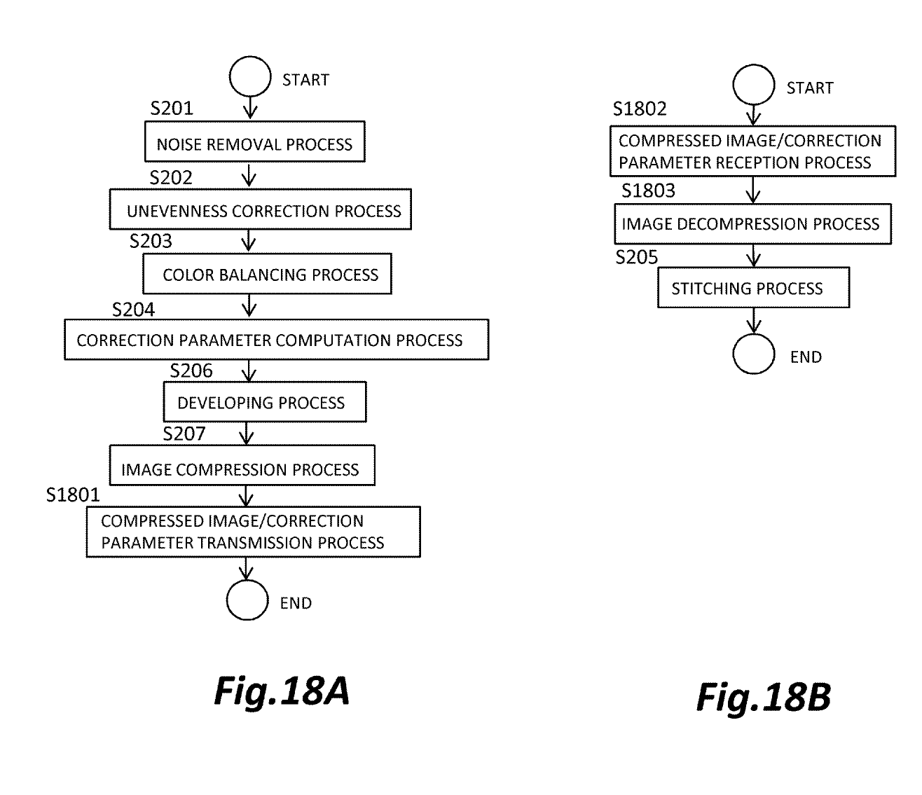

The construction of the digital microscope according to the sixth embodiment is the same as the first embodiment. The sixth embodiment differs from the first embodiment in the distribution of the processes to be executed to the image processing apparatus 109 and the computer 110. In consequence, the format of image transmitted from the image processing apparatus 109 to the computer 110 is also different between the sixth and first embodiments. In the following what is different from the first embodiment will be mainly described. FIG. 18A is a flow chart of the process executed in the image processing apparatus 109. FIG. 18B is a flow chart of the process executed in the computer 110.

The image processing apparatus 109 executes image processing in accordance with the procedure shown in FIG. 18A. Among the process steps in the image processing, the noise removal process (S201), the unevenness correction process (S202), and the color balancing process (S203), through which captured small image data 136 is processed into monochromatic small image data 220, are the same as those in the first embodiment. The correction parameter computation process (S204), in which parameters used in positional displacement/deformation correction processing applied to color small image data 221, and developing process (S206) and compression process (S207), in which common image processing techniques are used, are also the same as those in the first embodiment. In the first embodiment, single overall image data is generated in the stitching process (S205) after the computation of parameters in the correction parameter computation process. In the sixth embodiment, development and still image compression are applied to monochromatic image data 220 before stitching process is applied thereto, and compressed data of the small images is transmitted to the computer 110. At the same time, correction parameters for stitching are also transmitted. The transmission to the computer 110 is executed in a compressed image/correction parameter transmission process (S1801).

The computer 110 executes image processing in accordance with the procedure shown in FIG. 18B. The compressed data of small images and the correction parameters for positional displacement/deformation correction transmitted by the image processing apparatus 109 are received in a compressed data and correction parameter reception process (S1802). Thereafter, the compressed data of small images is decompressed through an image decompression process (S1803) and loaded in the internal memory of the computer 110.

In a stitching process (S205), single overall image data is generated based on the loaded data of small images and the received correction parameters. The processing performed in the stitching process (S205) is the same as that in the first embodiment. By the above-described process steps, stitched overall image data can be generated without transmission of an uncompressed image of a large data size to the computer 110.

In the sixth embodiment, the correction parameter computation process (S204) is executed in the image processing apparatus 109. The mode of the embodiment is not limited to this, but the system may be configured in such a way that the correction parameter computation process (S204) is executed by the computer 110. When this is the case, the measurement values 138 of the position after driving of the tilt angle control actuator 105, the measurement values 138 of the position after driving of the depth control actuator 106, and the measurement values 138 of the position after driving of the three-axis stage 103 with respect to the x and y directions are transmitted to the computer 110. The measurement values may be transmitted either from the control apparatus 108 holding the measurement values or from the image processing apparatus 109 together with the compressed data of small images.

As described above, in the digital microscope according to the sixth embodiment, at least the stitching process is executed in the computer 110. This enables a further reduction of the time taken by the image stitching process in the digital microscope according to the sixth embodiment. Moreover, since the image processing performed in the image processing apparatus is a process commonly performed by typical imaging systems, parts and programs available in the market can be used. This can lead to a further reduction in the manufacturing cost of the digital microscope.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-024087, filed on Feb. 7, 2012, Japanese Patent Application No. 2012-024150, filed on Feb. 7, 2012, and Japanese Patent Application No. 2013-015743, filed on Jan. 30, 2013, which are hereby incorporated by reference herein in their entirety.

### REFERENCE SIGNS LIST

102: specimen holding unit
103: three-axis stage
104: image sensor
105: tilt angle control actuator
106: depth control actuator
107: laser displacement gauge
108: control apparatus
109: image processing apparatus

1. An image forming apparatus configured to form an overall image of an object by stitching a plurality of small images captured by imaging the object a plurality of times while changing the imaging position, comprising:
an imaging element;
a holding member configured to hold an object;
at least one of a drive system configured to drive the imaging element in one or a plurality of directions to change a position of the imaging element and a drive system that drives the holding member in one or a plurality of directions to change a position of the holding member;
a drive control unit configured to drive the drive system, every time a small image is captured, in such a way that the positions of the imaging element and the holding member are set to predetermined positions that are determined in such a way that imaging is performed at a target imaging position;
an obtaining unit configured to obtain, as after-driving position information, at least one of the position of the imaging element with respect to the one or plurality of directions after driving by the drive system and the position of the holding member with respect to the one or plurality of directions after driving by the drive system by estimation;
a correction unit configured to correct deformation of the small images caused by a difference between the target imaging position and an actual imaging position, based on the after-driving position information;
a forming unit configured to form an overall image of the object by stitching the small images after correction; and
a memory unit configured to store information about an influence of the drive direction on at least the last occasion of driving by the drive system on the position of the imaging element or the holding member after the next occasion of driving,
wherein the obtaining unit obtains the after-driving position information by estimating at least one of the position of the imaging element with respect to the one or plurality of directions after driving by the drive system and the position of the holding member with respect to the one or plurality of directions after driving by the drive system, based on the information stored in the memory unit and information about the drive direction on at least the last occasion of driving.

2. An image forming apparatus according to claim 1, further comprising a computation unit configured to compute the similarity of adjoining small images, among the plurality of small images captured by a plurality of times of imaging, in their overlapping area, wherein the correction unit corrects deformation of the small images caused by a difference between the target imaging position and the actual imaging position based on the after-driving position information and the similarity.

3. An image forming apparatus according to claim 1, wherein the correction unit further corrects deformation of the small images attributed to characteristics of an optical member provided in the image forming apparatus.

4-5. (canceled)

6. A control method for an image forming apparatus that is provided with an imaging element, a holding member configured to hold an object, and at least one of a drive system configured to drive the imaging element in one or a plurality of directions to change the position of the imaging element and a drive system that drives the holding member in one or a plurality of directions to change the position of the holding member, and is configured to form an overall image of an object by stitching a plurality of small images captured by imaging the object a plurality of times while changing the imaging position, comprising:
a drive control step of driving the drive system, every time a small image is captured, in such a way that the positions of the imaging element and the holding member are set to predetermined positions that are determined in such a way that imaging is performed at a target imaging position;
an obtaining step of obtaining, as after-driving position information, at least one of the position of the imaging element with respect to the one or plurality of directions after driving by the drive system and the position of the holding member with respect to the one or plurality of directions after driving by the drive system by estimation;
a correction step of correcting deformation of the small images caused by a difference between the target imaging position and an actual imaging position, based on the after-driving position information; and
a forming step of forming an overall image of the object by stitching the small images after correction,
wherein in the obtaining step, the after-driving position information is obtained by estimating at least one of the position of the imaging element with respect to the one or plurality of directions after driving by the drive system and the position of the holding member with respect to the one or plurality of directions after driving by the drive system, based on information about an influence of the drive direction on at least the last occasion of driving by the drive system on the position of the imaging element or the holding member after the next occasion of driving and information about the drive direction on at least the last occasion of driving.

7. A control method for an image forming apparatus according to claim 6, further comprising a computation step of computing the similarity of adjoining small images, among the plurality of small images captured by a plurality of times of imaging, in their overlapping area, wherein in the correction step, deformation of the small images caused by a difference between the target imaging position and the actual imaging position is corrected based on the after-driving position information and the similarity.

8. A control method for an image forming apparatus according to claim 6, wherein in the correction step, deformation of the small images attributed to characteristics of an optical member provided in the image forming apparatus is further corrected.

9-10. (canceled)
